(19) United States
(12) Patent Application Publication
(10) Pub. No.: US 2023/0319678 A1
(43) Pub. Date: Oct. 5, 2023

(54) USER EQUIPMENT ROUTING SELECTION POLICY TRAFFIC CATEGORIES

(71) Applicant: Apple Inc., Cupertino, CA (US)

(72) Inventors: Vivek G. Gupta, San Jose, CA (US); Krisztian Kiss, Hayward, CA (US); Sridhar Prakasam, Woodside, CA (US); Sudeep Manithara Vamanan, Nuremburg (DE)

(73) Assignee: Apple Inc., Cupertino, CA (US)

(21) Appl. No.: 18/183,445

(22) Filed: Mar. 14, 2023

Related U.S. Application Data
(60) Provisional application No. 63/325,128, filed on Mar. 29, 2022.

(51) Int. Cl. H04W 40/12; H04W 28/02

(52) U.S. Cl. CPC H04W 40/12; H04W 28/0268

(57) ABSTRACT

The present application relates to devices and components including apparatus, systems, and methods to utilize traffic descriptors for user equipment routing selection policy.

### CROSS-REFERENCE TO RELATED APPLICATIONS

This application claims priority to U.S. provisional application No. 63/325,128, entitled “User Equipment Routing Selection Policy Traffic Categories,” filed on Mar. 29, 2022, the disclosure of which is incorporated by reference herein in its entirety for all purposes.

### TECHNICAL FIELD

The present application relates to the field of wireless technologies and, in particular, to user equipment routing selection policy traffic categories.

### BACKGROUND

Third Generation Partnership Project (3GPP) networks provide for routing of traffic of user equipments (UEs) within the networks. In particular, traffic of the UEs may be routed to different resources within the networks to provide services for UEs. One approach for determining which resources the traffic of a UE is the use of UE routing selection policy (URSP) traffic descriptors. However, the types of URSP traffic descriptors have been limited in the 3GPP networks.

### BRIEF DESCRIPTION OF THE DRAWINGS

FIG. 1 illustrates a table illustrating an example structure related to user equipment routing selection policy (URSP) rules in accordance with some embodiments.

FIG. 2 illustrates a table of example legacy traffic descriptors in accordance with some embodiments.

FIG. 3 illustrates a table of example traffic descriptors in accordance with some embodiments.

FIG. 4 illustrates a table of example traffic descriptors in accordance with some embodiments.

FIG. 5 illustrates a table of example traffic descriptors in accordance with some embodiments.

FIG. 6 illustrates a table of example traffic descriptors in accordance with some embodiments.

FIG. 7 illustrates an example system in accordance with some embodiments.

FIG. 8 illustrates another example system in accordance with some embodiments.

FIG. 9 illustrates an example procedure providing a traffic descriptor for traffic in accordance with some embodiments.

FIG. 10 illustrates an example procedure for routing traffic of a user equipment (UE) and/or providing URSP rules in accordance with some embodiments.

FIG. 11 illustrates an example procedure for provisioning URSP rules in accordance with some embodiments.

FIG. 12 illustrates an example UE in accordance with some embodiments.

FIG. 13 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

This disclosure is directed at least in part to a user equipment (UE) policy enhancement. In particular, the disclosure is directed to new traffic categories for UE policy enhancement. For example, the traffic of a UE in third generation partnership project (3GPP) network may be routed to different resources of the network based on UE routing selection policy (URSP) traffic descriptors. The defined traffic descriptors of legacy 3GPP network systems are limited. This disclosure presents defined additional URSP traffic descriptors related to new traffic categories not included in the legacy URSP traffic descriptors for 3GPP networks. These additional URSP traffic descriptors may be utilized for routing of traffic of UEs within the 3GPP networks that can enhance and/or improve service provided to the UEs. The additional URSP traffic descriptors may be implemented by a 3GPP network system (such as a fifth generation (5G) network system in some embodiments) for routing of traffic of UEs connected to the network system.

UE Policy Enhancement—New Traffic Categories

3GPP release 18 (Rel-18) has approved a new Study Item on UE Policy Enhancement (SP-211649. (9-10 Dec. 2021). New SID: Study on enhancement of 5G UE Policy. TSG SA Rel-18 Prioritization Workshop).

Groupe Speciale Mobile Association (GSMA) has sent a liaison statement (LS) to SA2 (S2-2105356. (16-27 Aug. 2021). LS on Traffic Categories in URSP. SA WG2 Meeting #52-146E) in August 2021 wherein GSMA has profiled the use of user equipment routing selection policy (URSP) in their permanent reference document (PRD) NG.114 (NG.114. (7 Aug. 2020). IMS Profile for Voice, Video and Messaging over 5GS. GSM Association) and NG.113 (NG.113. (28 May 2021). 5GS Roaming Guidelines. GSM Association) based on use of URSP functionality in 3GPP technical specification (TS) 23.503 (TS 23.503. “3^{rd} Generation Partnership Project; Technical Specification Group Services and System Aspects; Policy and charging control framework for the 5G System (5GS); Stage 2 (Release 17).” 3GPP Organization Partners, March 2022.) and TS 24.526 (TS 24.526. “3^{rd} Generation Partnership Project; Technical Specification Group Core Network and Terminals; User Equipment (UE) policies for 5G System (5GS); Stage 3 (Release 17).” 3GPP Organization Partners, December 2021.). GSMA has concluded that standardized and mobile network operator (MNO) specific traffic categories need to supported in URSP traffic descriptors. Standardized traffic categories could be defined by 3GPP or by GSMA. MNO-specific traffic categories should be represented by a number of octets (flexible format to allow any string).

Examples of these traffic categories are Enterprise, Gaming, and Video Streaming. Enterprise may include traffic from one or more applications related to Enterprise service. Gaming may include traffic from one or more applications related to Gaming service, e.g., with low latency requirement. Video Streaming may include traffic from one or more applications related to Video Streaming, e.g., high-definition (HD) video streaming, 4K video streaming. A given traffic category can be used by more than one application simultaneously, and one application can simultaneously use more than one traffic category.

In the UE Policy Study Item objective #6 aims to investigate how to support standardized and operator specific traffic categories in the traffic descriptor of URSP. 3GPP has defined two major policy components for access in 5GC (WLAN): 1) UE route selection policy URSP which is a prioritized list of URSP rules provisioned by policy control function (PCF); and 2) Access Network discovery and selection policy (ANDSP) for non-3GPP access. The UE Route Selection Policy URSP may consist of Rule precedence, Traffic descriptors and Route Selection descriptors. The Access Network discovery and selection policy (ANDSP) for non-3GPP access may consist of wireless local area network (WLAN) Selection policy components for selection of WLAN and Non-3GPP access network (N3AN) node configuration information for selection of non-3GPP interworking function (N3IWF) or evolved packet data gateway (ePDG).

UE Policy Enhancement—Issue (SA2 TR 23.700-85 (TR 23.700-85. “3^{rd} Generation Partnership Project; Technical Specification Group Services and System Aspects; Study on enhancement of 5G User Equipment (UE) policy (Release 18).” 3GPP Organization Partners, March 2022.))

3GPP SA2 has agreed the following issue: Support standardized and operator-specific traffic categories in URSP. SA2 will investigate how to support traffic categories in the traffic descriptor of URSP. Following aspects will be considered: 1) Definition of Traffic Category use cases and how to support both standardized traffic categories and MNO-specific traffic categories. If standardized values for traffic categories are defined, what are the various traffic categories that need to be standardized; 2) Whether the existing URSP design can be used to support the traffic category. If not, how to support traffic category in the traffic descriptor of a URSP rule; and 3) Traffic categories should support mechanisms that enable the UE to uniquely identify and categorize the traffic generated by any active application in a consistent manner across UE implementations.

General Concept—New Traffic Categories

Examples of these traffic categories based on application or specific service types are enterprise, gaming, and video streaming. Enterprise may include traffic from one or more applications related to Enterprise services. For example, the enterprise traffic category may include traffic of a UE related to applications for enterprise services, such for applications executed in an office setting, applications related to electronic mail (“email” or “e-mail”) file downloads, applications related to email, applications related to audio or video conferencing, applications related to browsing the internet, applications related to electronic messaging, or other applications that are defined or registered as being associated with enterprises. Gaming traffic category may include traffic from one or more applications related to Gaming service, for example, with low latency requirement. For example, the gaming traffic category may include traffic of a UE related to gaming applications, which may benefit from real-time traffic and/or low-latency traffic. Video Streaming traffic category may include traffic from one or more applications related to Video Streaming, for example, HD video streaming, 4K video streaming. For example, the video streaming traffic category may include traffic of a UE related to applications, and/or particular services of applications, related to video streaming, such as HD video streaming, 4K video streaming, and/or other video streaming.

Traffic in each category can be categorized by application/service type which can point to a range of values for a set of QoS related attributes. These QoS related attributes can be as follows: 1) Priority level (scheduling priority among flows); 2) Packet delay budget (latency); 3) Packet error rate (congestion and reliability); 4) Burst window (max throughput per unit time); and 5) Averaging window (guaranteed flow bit rate over unit time).

In addition to above traffic categories can also be: 1) MNO (Mobile Network Operator) specific; and 2) Best QoS (which can also be referred to as “optimal QoS request”). Best QoS can be expected in a slice. Best QoS can include traffic from an application that requires a specific QoS (specific parameters) but does not have exact mapping to a category included above.

Traffic descriptors can be defined either based on: 1) Service type of application (email, video, gaming etc.) which can point to a range of values for a set of QoS related attributes or 2) Traffic characteristics (just QoS attributes with no mapping to service/application types). Specific QoS attributes could have a relative priority level. As an example there could be relative priority among the QoS attributes (e.g. low latency, high bandwidth slice with latency as higher priority). Specific QoS attributes could have a range of values. Priority in a slice can be given to a single or multiple QS attributes (e.g. prioritize latency and packet error rate over bandwidth for something like voice traffic, gaming response traffic, etc.).

UE Policy Enhancement—URSP Traffic Descriptors (TS 23.503)

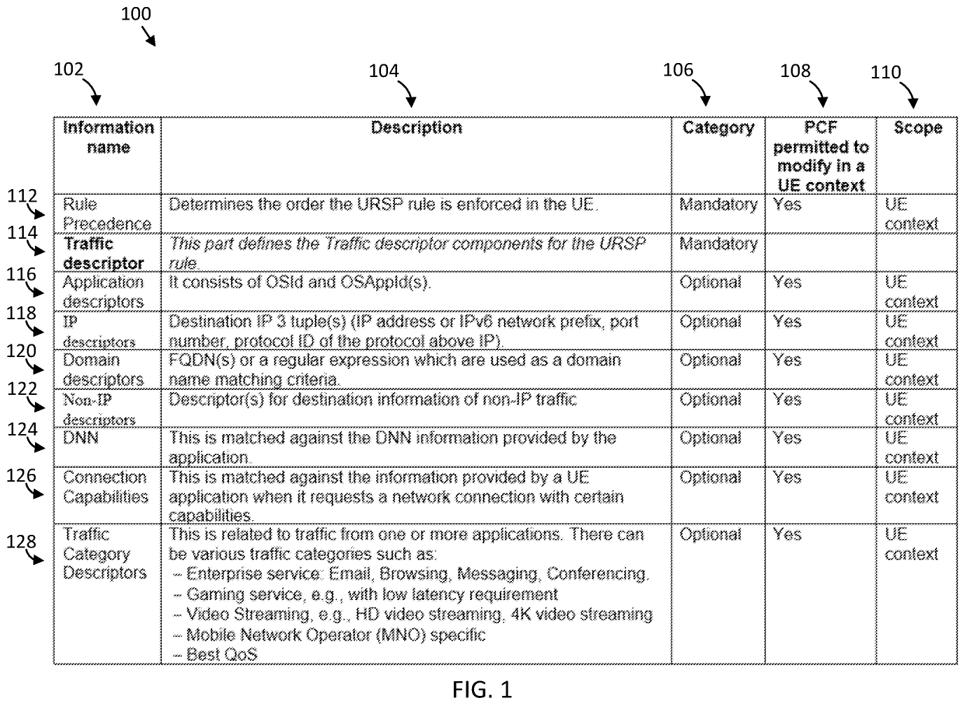

FIG. 1 illustrates a table 100 illustrating an example structure related to URSP rules in accordance with some embodiments. In particular, the table 100 illustrates one or more elements that may be included in a structure of URSP rules. The URSP rules may be utilized for determining a traffic descriptor to be utilized with traffic of a UE. The table 100 may be similar to Table 6.6.2.1-2 of TS 23.503 with the addition of elements to be included in a structure related to URSP rules defined herein.

The table 100 includes information names 102, description 104, category indicator 106, PCF modification permission 108, and scope 110 for each of the elements that may be included in a structure of URSP rules. For example, the information names 102 may provide a defined information name for an element of the structure. The description 104 may provide a description of a corresponding element of the structure. The category indicator 106 may indicate a category of the corresponding element of the structure. The PCF modification permission 108 may indicate whether a corresponding element of the structure is permitted to be modified by a PCF in a UE context. The scope 110 may indicate the scope of a corresponding element of the structure.

The structure may include a rule precedence element 112 as illustrated in the table 100. The rule precedence element 112 may determine the order the URSP rule is enforced in the UE, as indicated by the description 104 corresponding to the rule precedence element 112. In some embodiments, the rule precedence element 112 may be mandatory, as indicated by the category indicator 106 corresponding to the rule precedence element 112. In other embodiments, the rule precedence element 112 may be optional. Rules in a URSP may have different precedence values. In some embodiments, the PCF may be permitted to modify in a UE context the rule precedence element 112, as indicated by the PCF modification permission 108 corresponding to the rule precedence element 112. In other embodiments, the PCF may not be permitted to modify in a UE context the rule precedence element 112. The scope of the rule precedence element 112 may be UE context as indicated by the scope 110 corresponding to the rule precedence element 112.

The structure may include a traffic descriptor element 114 as illustrated in the table 100. The traffic descriptor element 114 may define traffic descriptor components for the URSP rule, as indicated by the description 104 corresponding to the traffic descriptor element 114. In some embodiments, the traffic descriptor element 114 may be mandatory, as indicated by the category indicator 106 corresponding to the traffic descriptor element 114. For example, at least one of the traffic descriptor components may be present in these embodiments. In other embodiments, the traffic descriptor element 114 may be optional. In some embodiments, the PCF may be permitted to modify in a UE context the traffic descriptor element 114. In other embodiments, the PCF may not be permitted to modify in a UE context the traffic descriptor element 114. The scope of the traffic descriptor element 114 may be UE context as indicated by the scope 110 corresponding to the traffic descriptor element 114.

The structure may include application descriptors element 116 as illustrated in the table 100. The application descriptors element 116 may include an operating system identifier (OSId) and/or one or more operating system application identifiers (OSAppIds), as indicated by the description 104 corresponding to the application descriptors element 116. This information may be used to identify the application(s) that is(are) running on the UE's operating system (OS). The OSId may not include an OS version number. The OSAppId may not include a version number for the application. In some embodiments, the application descriptors element 116 may be optional, as indicated by the category indicator 106 corresponding to the application descriptors element 116. In other embodiments, the application descriptors element 116 may be mandatory. In some embodiments, the PCF may be permitted to modify in a UE context the application descriptors element 116, as indicated by the PCF modification permission 108 corresponding to the application descriptors element 116. In other embodiments, the PCF may not be permitted to modify in a UE context the application descriptors element 116. The scope of the application descriptors element 116 may be UE context as indicated by the scope 110 corresponding to the application descriptors element 116.

The structure may include internet protocol (IP) descriptors element 118 as illustrated in the table 100. In some embodiments, a URSP rule may not contain the combination of the traffic descriptor components IP descriptors and Non-IP descriptors. The IP descriptors element 118 may include destination IP 3 tuple(s) (which may include IP address or IPv6 network prefix, port number, and/or protocol identifier (ID) of the protocol above IP), as indicated by the description 104 corresponding to the IP descriptors element 118. In some embodiments, the IP descriptors element 118 may be optional, as indicated by the category indicator 106 corresponding to the IP descriptors element 118. In other embodiments, the IP descriptors element 118 may be mandatory. In some embodiments, the PCF may be permitted to modify in a UE context the IP descriptors element 118, as indicated by the PCF modification permission 108 corresponding to the IP descriptors element 118. In other embodiments, the PCF may not be permitted to modify in a UE context the IP descriptors element 118. The scope of the IP descriptors element 118 may be UE context as indicated by the scope 110 corresponding to the IP descriptors element 118.

The structure may include domain descriptors element 120 as illustrated in the table 100. The domain descriptors element 120 may include fully-qualified domain name(s) (FQDN(s)) or a regular expression which are used as domain name matching criteria, as indicated by the description 104 corresponding to the domain descriptors element 120. The match of this traffic descriptor may not require successful domain name system (DNS) resolution of the FQDN provided by the UE application. In some embodiments, the domain descriptors element 120 may be optional, as indicated by the category indicator 106 corresponding to the domain descriptors element 120. In other embodiments, the domain descriptors element 120 may be mandatory. In some embodiments, the PCF may be permitted to modify in a UE context the domain descriptors element 120, as indicated by the PCF modification permission 108 corresponding to the domain descriptors element 120. In other embodiments, the PCF may not be permitted to modify in a UE context the domain descriptors element 120. The scope of the domain descriptors element 120 may be UE context as indicated by the scope 110 corresponding to the domain descriptors element 120.

The structure may include non-IP descriptors element 122 as illustrated in the table 100. In some embodiments, a URSP rule may not contain the combination of the traffic descriptor components IP descriptors and non-IP descriptors. The non-IP descriptors element 122 may include descriptor(s) for destination information non-IP traffic, as indicated by the description 104 corresponding to the non-IP descriptors element 122. In some embodiments, the non-IP descriptors element 122 may be optional, as indicated by the category indicator 106 corresponding to the non-IP descriptors element 122. In other embodiments, the non-IP descriptors element 122 may be mandatory. In some embodiments, the PCF may be permitted to modify in a UE context the non-IP descriptors element 122, as indicated by the PCF modification permission 108 corresponding to the non-IP descriptors element 122. In other embodiments, the PCF may not be permitted to modify in a UE context the non-IP descriptors element 122. The scope of the non-IP descriptors element 122 may be UE context as indicated by the scope 110 corresponding to the non-IP descriptors element 122.

The structure may include data network name (DNN) element 124 as illustrated in the table 100. The DNN element 124 may be matched against the DNN information provided by the application, as indicated by the description 104 corresponding to the DNN element 124. For example, a value of the DNN element 124 may be matched against the DNN information provided by the application. In some embodiments, the DNN element 124 may be optional, as indicated by the category indicator 106 corresponding to the DNN element 124. In other embodiments, the DNN element 124 may be mandatory. In some embodiments, the PCF may be permitted to modify in a UE context the DNN element 124, as indicated by the PCF modification permission 108 corresponding to the DNN element 124. In other embodiments, the PCF may not be permitted to modify in a UE context the DNN element 124. The scope of the DNN element 124 may be UE context as indicated by the scope 110 corresponding to the DNN element 124.

The structure may include connection capabilities element 126 as illustrated in the table 100. The connection capabilities element 126 may be matched against the information provided by a UE application when it requests a network connection with certain capabilities, as indicated by the description 104 corresponding to the connection capabilities element 126. For example, a value of the connection capabilities element 126 may be matched against the information provided by a UE application when it requests a network connection with certain capabilities. The format and some values of connection capabilities, e.g. “ims”, “mms”, “internet”, etc., may be defined by TS 24.526. More than one connection capabilities value can be provided. In some embodiments, the connection capabilities element 126 may be optional, as indicated by the category indicator 106 corresponding to the connection capabilities element 126. In other embodiments, the connection capabilities element 126 may be mandatory. In some embodiments, the PCF may be permitted to modify in a UE context the connection capabilities element 126, as indicated by the PCF modification permission 108 corresponding to the connection capabilities element 126. In other embodiments, the PCF may not be permitted to modify in a UE context the connection capabilities element 126. The scope of the connection capabilities element 126 may be UE context as indicated by the scope 110 corresponding to the connection capabilities element 126.

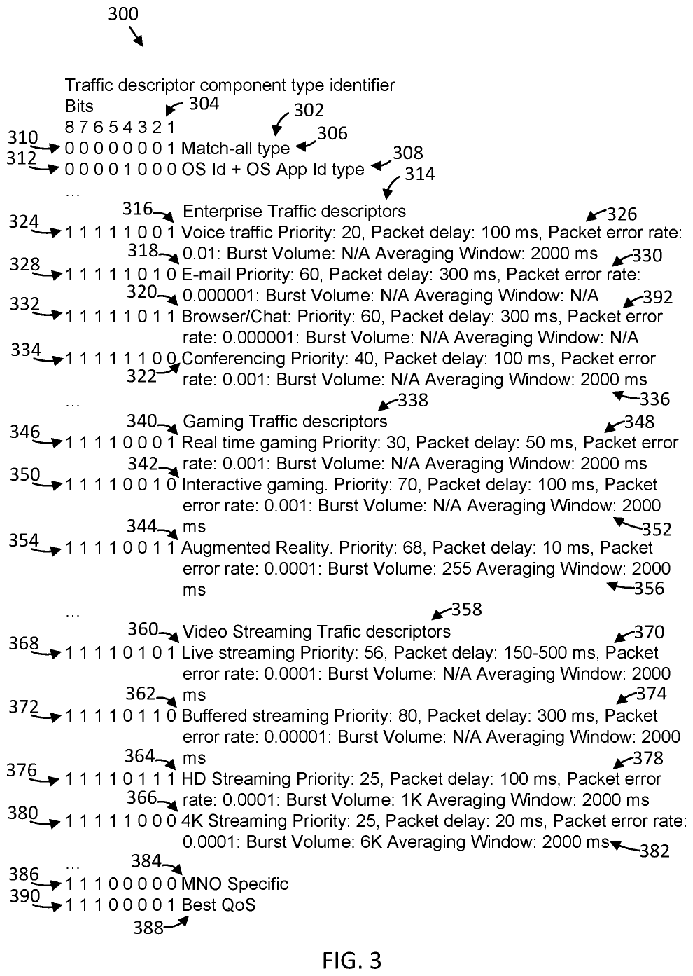

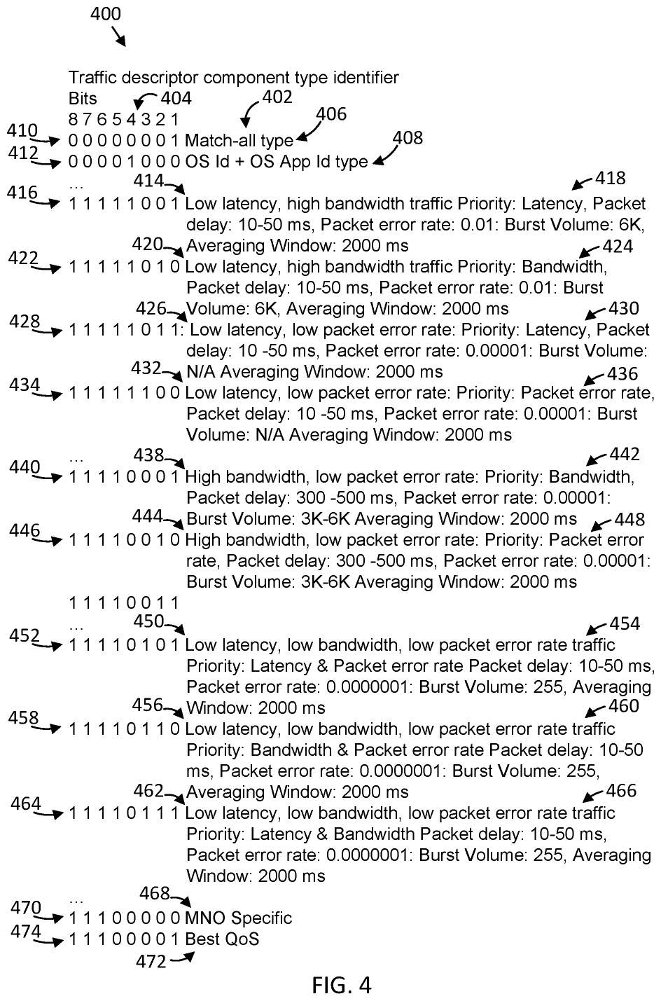

The structure may include traffic category descriptors element 128 as illustrated in the table 100. The traffic category descriptors element 128 may include the additional traffic descriptors defined herein. The traffic descriptors of the traffic category descriptors element 128 may relate to traffic categories introduced herein. The traffic category descriptors element 128 may be related to traffic from one or more applications, as indicated by the description 104 corresponding to the traffic category descriptors element 128. The various traffic categories may include an enterprise service category, a gaming service category, a video streaming category, a MNO specific category, a best QoS category (which may be referred to as an “optimal QoS request category), or some combination thereof. The enterprise service category may include traffic relating to email, browsing, messaging, conferencing, or some combination thereof. The gaming service category may include traffic with a low latency requirement. The video streaming category may include traffic related to HD video streaming, 4K video streaming, or some combination thereof. The traffic descriptors corresponding to the traffic categories are described in further detail in relation to FIG. 3 and FIG. 4.

In some embodiments, the traffic category descriptors element 128 may be optional, as indicated by the category indicator 106 corresponding to the traffic category descriptors element 128. In other embodiments, the traffic category descriptors element 128 may be mandatory. In some embodiments, the PCF may be permitted to modify in a UE context the traffic category descriptors element 128, as indicated by the PCF modification permission 108 corresponding to the traffic category descriptors element 128. In other embodiments, the PCF may not be permitted to modify in a UE context the traffic category descriptors element 128. The scope of the traffic category descriptors element 128 may be UE context as indicated by the scope 110 corresponding to the traffic category descriptors element 128.

UE Policy Enhancement—Legacy URSP Traffic Descriptors (TS 24.526)

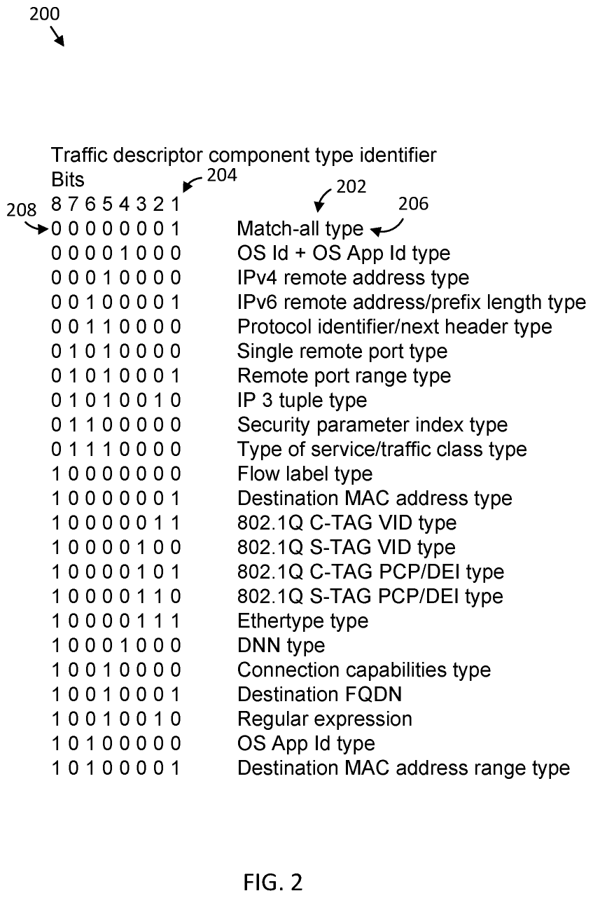

FIG. 2 illustrates a table 200 of example legacy traffic descriptors 202 in accordance with some embodiments. In particular, the values of the traffic descriptors 202 may be utilized in the traffic descriptor element 114 (FIG. 1) of the structure in a communication. The traffic descriptors 202 may be utilized for routing traffic of a UE in some embodiments. The table 200 may be similar to a portion of the table 5.2.1 of TS 24.526.

The table 200 includes the list of traffic descriptors 202. Further, the table 200 includes values 204 corresponding to the traffic descriptors 202. Each of the traffic descriptors 202 may have a corresponding value from the values 204. As illustrated in the table 200, each of the values 204 may comprise eight bits. For example, a match-all type traffic descriptor 206 may correspond to a first value 208 of ‘00000001’. Including the first value 208 in the traffic descriptor element 114 may indicate that the traffic descriptor for a UE providing the structure is the match-all type traffic descriptor 206. The traffic from the UE providing the structure may be routed in accordance with the traffic descriptor 206. All other values not illustrated in the values 204 may be spare. If the other values are received (for example, included in the structure in a communication), the other values may be interpreted as unknown.

UE Policy Enhancement—URSP Traffic Descriptors for New Traffic Categories

Additional traffic descriptors may be defined for use in the structure illustrated by the table 100 (FIG. 1) in the traffic category descriptors element 128 (FIG. 1). In some of these embodiments, the additional traffic descriptors may be based on application and/or service types. For example, the traffic descriptor for traffic of a UE may be based on an application being executed by the UE corresponding to the traffic and/or a service being provided by the UE corresponding to the traffic. A UE may provide a communication with the traffic category descriptors element 128 being set to the value of one of the additional traffic descriptors, where the traffic of the UE corresponding to the communication may be routed based on value of the additional traffic descriptor.

FIG. 3 illustrates a table 300 of example traffic descriptors 302 in accordance with some embodiments. The traffic descriptors 302 may be used for the traffic category descriptors element 128 (FIG. 1). In particular, a value of a determined traffic descriptor from the traffic descriptors 302 may be included in the traffic category descriptors element 128 of a communication from a UE, where the traffic descriptor may be utilized for determining routing of traffic related to the communication.

The table 300 illustrates the traffic descriptors 302 with corresponding values 304. In particular, the values 304 may be utilized in the traffic category descriptor element 128 to indicate the corresponding traffic descriptors 302. As shown in the illustrated in the table 300, the values 304 may be an eight bit value in some embodiments. A UE may determine a traffic descriptor of the traffic descriptors 302 for traffic based on an application associated with the traffic, a service type associated with the traffic, an MNO specification defined for the traffic, or some combination thereof. The UE may provide a communication with the value of the values 304 corresponding to the determined traffic descriptor to indicate routing for the traffic.

The traffic descriptors 302 may include a match-all type traffic descriptor 306 and/or an OS Id+OS App ID type traffic descriptor 308. The match-all type traffic descriptor 306 may be equivalent to the match-all type traffic descriptor 206 (FIG. 2) in the traffic descriptors 202 (FIG. 2). The match-all type traffic descriptor 306 may correspond to a first value 310, the first value 310 being equal to ‘00000001’. The OS Id+OS App ID type traffic descriptor 308 may be equivalent to an OS Id+OS App ID type traffic descriptor in the traffic descriptors 202 (FIG. 2). The OS Id+OS App ID type traffic descriptor 308 may correspond to a second value 312, the second value 312 being equal to ‘00001000’.

Some of the traffic descriptors 302 may by service type traffic descriptors in the table 300. For example, each of these traffic descriptors in the portion of the traffic descriptors 302 may correspond to an application and/or a service type of an application, where the traffic descriptor to be utilized for the routing may be determined based on the application and/or the service type of the application. These traffic descriptors 302 may be divided into enterprise traffic descriptors 314, gaming traffic descriptors 338, and video streaming traffic descriptors 358. The traffic descriptors 302 (or some portion thereof, such as the enterprise traffic descriptors 314, the gaming traffic descriptors 338, and the video streaming traffic descriptors 358) may be expressed in terms of one or more QoS attributes, such as a priority, a packet delay, an error rate, a burst volume, an averaging window, or some combination thereof.

The enterprise traffic descriptors 314 may be utilized for UE traffic related to enterprises, such as traffic from an office setting, traffic related to email (including email file downloads), traffic related to audio or video conferencing, traffic related to browsing the internet, traffic related to electronic messaging, and/or traffic for applications defined or registered as being associated with enterprises. In some embodiments, the enterprise traffic descriptors 314 may define a particular routing (which may be referred to as a pipe) for all traffic associated with an enterprise. For example, the enterprise traffic descriptors 314 may not differentiate between traffic based on traffic characteristics when routing the traffic, and may instead route all the traffic associated with the enterprise traffic descriptors 314 by a same routing. Accordingly, the enterprise traffic descriptors 314 may be a good fit for the type of traffic of the enterprise, which may be referred to as a best effort. The enterprise traffic descriptors 314 may include a voice traffic descriptor 316, an email traffic descriptor 318, a browser/chat traffic descriptor 320, and/or a conferencing traffic descriptor 322, as illustrated in the table 300. Each of the enterprise traffic descriptors 314 may have corresponding values used to indicate the enterprise traffic descriptors 314 and/or corresponding attributes for the enterprise traffic descriptors 314.

The voice traffic descriptor 316 may be utilized for applications related to voice communication (such as telephone communication and/or voice over internet protocol (VoIP)). For example, a UE may determine that an application being executed by the UE and/or a service being provided by the UE is related to voice communication. Based on the determination that the application and/or the service is related to voice communication, the UE may determine that the voice traffic descriptor 316 is to be utilized for indicating the routing of traffic for the application and/or the service.

The voice traffic descriptor 316 may have a corresponding third value 324 that can be utilized to indicate the voice traffic descriptor 316. The UE may provide the third value 324 in a communication that can indicate that the traffic associated with the communication is to be routed in accordance with the voice traffic descriptor 316. In the illustrated embodiment, the third value 324 is ‘11111001’, although it should be understood that the third value 324 may be different in other embodiments.

The voice traffic descriptor 316 may have corresponding attributes 326 for the traffic related to the voice traffic descriptor 316, where the routing of the traffic may be performed to achieve the attributes 326. For example, the attributes 326 may include a priority indication, a packet delay indication, a packet error rate indication, a burst volume indication, an averaging window indication, or some combination thereof. In the illustrated embodiments, the attributes 326 for the voice traffic descriptor 316 are shown as a priority value of 20, a packet delay value of 100 milliseconds (ms), a packet error rate value of 0.01, and an averaging window of 2000 ms. In this embodiment, the burst volume is not applicable. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the voice traffic descriptor 316 to meet these attribute values.

The email traffic descriptor 318 may be utilized for applications related to email (including email file downloads). For example, a UE may determine that an application being executed by the UE and/or a service being provided by the UE is related to email. Based on the determination that the application and/or the service is related to email, the UE may determine that the email traffic descriptor 318 is to be utilized for indicating the routing of traffic for the application and/or the service.

The email traffic descriptor 318 may have a corresponding fourth value 328 that can be utilized to indicate the email traffic descriptor 318. The UE may provide the fourth value 328 in a communication that can indicate that the traffic associated with the communication is to be routed in accordance with the email traffic descriptor 318. In the illustrated embodiment, the fourth value 328 is ‘11111010’, although it should be understood that the fourth value 328 may be different in other embodiments.

The email traffic descriptor 318 may have corresponding attributes 330 for the traffic related to the email traffic descriptor 318, where the routing of the traffic may be performed to achieve the attributes 330. For example, the attributes 330 may include a priority indication, a packet delay indication, a packet error rate indication, a burst volume indication, an averaging window indication, or some combination thereof. In the illustrated embodiments, the attributes 330 for the email traffic descriptor 318 are shown as a priority value of 60, a packet delay value of 300 ms, and a packet error rate value of 0.000001. In this embodiment, the burst volume and the averaging window are not applicable. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the email traffic descriptor 318 to meet these attribute values.

The browser/chat traffic descriptor 320 may be utilized for applications related to a browser (such as a browser application utilized for browsing the internet) and/or chat (such as a chat application that can be utilized for text chatting between two or more users). For example, a UE may determine that an application being executed by the UE and/or a service being provided by the UE is related to browsing and/or chat. Based on the determination that the application and/or the service is related to browsing and/or chat, the UE may determine that the browser/chat traffic descriptor 320 is to be utilized for indicating the routing of traffic for the application and/or the service.

The browser/chat traffic descriptor 320 may have a corresponding fifth value 332 that can be utilized to indicate the browser/chat traffic descriptor 320. The UE may provide the fifth value 332 in a communication that can indicate that the traffic associated with the communication is to be routed in accordance with the browser/chat traffic descriptor 320. In the illustrated embodiment, the fifth value 332 is ‘11111011’, although it should be understood that the fifth value 332 may be different in other embodiments.

The browser/chat traffic descriptor 320 may have corresponding attributes 392 for the traffic related to the browser/chat traffic descriptor 320, where the routing of the traffic may be performed to achieve the attributes 392. For example, the attributes 392 may include a priority indication, a packet delay indication, a packet error rate indication, a burst volume indication, an averaging window indication, or some combination thereof. In the illustrated embodiments, the attributes 392 for the browser/chat traffic descriptor 320 are shown as a priority value of 60, a packet delay value of 300 ms, and a packet error rate value of 0.000001. In this embodiment, the burst volume and the averaging window are not applicable. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the browser/chat traffic descriptor 320 to meet these attribute values.

The conferencing traffic descriptor 322 may be utilized for applications related to conferencing (such as video conferencing and/or audio conferencing). For example, a UE may determine that an application being executed by the UE and/or a service being provided by the UE is related to conferencing. Based on the determination that the application and/or the service is related to conferencing, the UE may determine that the conferencing traffic descriptor 322 is to be utilized for indicating the routing of traffic for the application and/or the service.

The conferencing traffic descriptor 322 may have a corresponding sixth value 334 that can be utilized to indicate the conferencing traffic descriptor 322. The UE may provide the sixth value 334 in a communication that can indicate that the traffic associated with the communication is to be routed in accordance with the conferencing traffic descriptor 322. In the illustrated embodiment, the sixth value 334 is ‘11111100’, although it should be understood that the sixth value 334 may be different in other embodiments.

The conferencing traffic descriptor 322 may have corresponding attributes 336 for the traffic related to the conferencing traffic descriptor 322, where the routing of the traffic may be performed to achieve the attributes 336. For example, the attributes 336 may include a priority indication, a packet delay indication, a packet error rate indication, a burst volume indication, an averaging window indication, or some combination thereof. In the illustrated embodiments, the attributes 336 for the conferencing traffic descriptor 322 are shown as a priority value of 40, a packet delay value of 100 ms, a packet error rate value of 0.001, and an averaging window of 2000 ms. In this embodiment, the burst volume is not applicable. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the conferencing traffic descriptor 322 to meet these attribute values.

The gaming traffic descriptors 338 may be utilized for UE traffic related to gaming services, such as gaming traffic with low latency requirement. The gaming traffic descriptors 338 may include a real time gaming traffic descriptor 340, an interactive gaming traffic descriptor 342, and/or an augmented reality traffic descriptor 344, as illustrated in the table 300. Each of the gaming traffic descriptors 338 may have corresponding values used to indicate the gaming traffic descriptors 338 and/or corresponding attributes for the gaming traffic descriptors 338.

The real time gaming traffic descriptor 340 may be utilized for applications related to real time gaming. For example, a UE may determine that an application being executed by the UE and/or a service being provided by the UE is related to real time gaming. Based on the determination that the application and/or the service is related to real time gaming, the UE may determine that the real time gaming traffic descriptor 340 is to be utilized for indicating the routing of traffic for the application and/or the service.

The real time gaming traffic descriptor 340 may have a corresponding seventh value 346 that can be utilized to indicate the real time gaming traffic descriptor 340. The UE may provide the seventh value 346 in a communication that can indicate that the traffic associated with the communication is to be routed in accordance with the real time gaming traffic descriptor 340. In the illustrated embodiment, the seventh value 346 is ‘11110001’, although it should be understood that the seventh value 346 may be different in other embodiments.

The real time gaming traffic descriptor 340 may have corresponding attributes 348 for the traffic related to the real time gaming traffic descriptor 340, where the routing of the traffic may be performed to achieve the attributes 348. For example, the attributes 348 may include a priority indication, a packet delay indication, a packet error rate indication, a burst volume indication, an averaging window indication, or some combination thereof. In the illustrated embodiments, the attributes 348 for the real time gaming traffic descriptor 340 are shown as a priority value of 30, a packet delay value of 50 ms, a packet error rate value of 0.001, and an averaging window of 2000 ms. In this embodiment, the burst volume is not applicable. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the real time gaming traffic descriptor 340 to meet these attribute values.

The interactive gaming traffic descriptor 342 may be utilized for applications related to interactive gaming. For example, a UE may determine that an application being executed by the UE and/or a service being provided by the UE is related to interactive gaming. Based on the determination that the application and/or the service is related to interactive gaming, the UE may determine that the interactive gaming traffic descriptor 342 is to be utilized for indicating the routing of traffic for the application and/or the service.

The interactive gaming traffic descriptor 342 may have a corresponding eighth value 350 that can be utilized to indicate the interactive gaming traffic descriptor 342. The UE may provide the eighth value 350 in a communication that can indicate that the traffic associated with the communication is to be routed in accordance with the interactive gaming traffic descriptor 342. In the illustrated embodiment, the eighth value 350 is ‘11110010’, although it should be understood that the eighth value 350 may be different in other embodiments.

The interactive gaming traffic descriptor 342 may have corresponding attributes 352 for the traffic related to the interactive gaming traffic descriptor 342, where the routing of the traffic may be performed to achieve the attributes 352. For example, the attributes 352 may include a priority indication, a packet delay indication, a packet error rate indication, a burst volume indication, an averaging window indication, or some combination thereof. In the illustrated embodiments, the attributes 352 for the interactive gaming traffic descriptor 342 are shown as a priority value of 70, a packet delay value of 50 ms, a packet error rate value of 0.001, and an averaging window of 2000 ms. In this embodiment, the burst volume is not applicable. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the interactive gaming traffic descriptor 342 to meet these attribute values.

The augmented reality traffic descriptor 344 may be utilized for applications related to augmented reality gaming. For example, a UE may determine that an application being executed by the UE and/or a service being provided by the UE is related to augmented reality gaming. Based on the determination that the application and/or the service is related to augmented reality gaming, the UE may determine that the augmented reality traffic descriptor 344 is to be utilized for indicating the routing of traffic for the application and/or the service.

The augmented reality traffic descriptor 344 may have a corresponding ninth value 354 that can be utilized to indicate the augmented reality traffic descriptor 344. The UE may provide the ninth value 354 in a communication that can indicate that the traffic associated with the communication is to be routed in accordance with the augmented reality traffic descriptor 344. In the illustrated embodiment, the ninth value 354 is ‘11110011’, although it should be understood that the ninth value 354 may be different in other embodiments.

The augmented reality traffic descriptor 344 may have corresponding attributes 356 for the traffic related to the augmented reality traffic descriptor 344, where the routing of the traffic may be performed to achieve the attributes 356. For example, the attributes 356 may include a priority indication, a packet delay indication, a packet error rate indication, a burst volume indication, an averaging window indication, or some combination thereof. In the illustrated embodiments, the attributes 356 for the augmented reality traffic descriptor 344 are shown as a priority value of 68, a packet delay value of 10 ms, a packet error rate value of 0.0001, a burst volume of 255 and an averaging window of 2000 ms. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the augmented reality traffic descriptor 344 to meet these attribute values.

The video streaming traffic descriptors 358 may be utilized for UE traffic related to video streaming, such as HD video streaming, 4K video streaming, and/or other video streaming. The video streaming traffic descriptors 358 may include a live streaming traffic descriptor 360, a buffered streaming traffic descriptor 362, an HD streaming traffic descriptor 364, and/or a 4K streaming traffic descriptor 366, as illustrated in the table 300. Each of the video streaming traffic descriptors 358 may have corresponding values used to indicate the video streaming traffic descriptors 358 and/or corresponding attributes for the video streaming traffic descriptors 358.

The live streaming traffic descriptor 360 may be utilized for applications related to live streaming of videos. For example, a UE may determine that an application being executed by the UE and/or a service being provided by the UE is related to live streaming of videos. Based on the determination that the application and/or the service is related to live streaming of videos, the UE may determine that the live streaming traffic descriptor 360 is to be utilized for indicating the routing of traffic for the application and/or the service.

The live streaming traffic descriptor 360 may have a corresponding tenth value 368 that can be utilized to indicate the live streaming traffic descriptor 360. The UE may provide the tenth value 368 in a communication that can indicate that the traffic associated with the communication is to be routed in accordance with the live streaming traffic descriptor 360. In the illustrated embodiment, the tenth value 368 is ‘11110101’, although it should be understood that the tenth value 368 may be different in other embodiments.

The live streaming traffic descriptor 360 may have corresponding attributes 370 for the traffic related to the live streaming traffic descriptor 360, where the routing of the traffic may be performed to achieve the attributes 370. For example, the attributes 370 may include a priority indication, a packet delay indication, a packet error rate indication, a burst volume indication, an averaging window indication, or some combination thereof. In the illustrated embodiments, the attributes 370 for the live streaming traffic descriptor 360 are shown as a priority value of 56, a packet delay value of 150-500 ms, a packet error rate value of 0.0001, and an averaging window of 2000 ms. In this embodiment, the burst volume is not applicable. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the live streaming traffic descriptor 360 to meet these attribute values.

The buffered streaming traffic descriptor 362 may be utilized for applications related to buffered streaming of videos. For example, a UE may determine that an application being executed by the UE and/or a service being provided by the UE is related to buffered streaming of videos. Based on the determination that the application and/or the service is related to buffered streaming of videos, the UE may determine that the buffered streaming traffic descriptor 362 is to be utilized for indicating the routing of traffic for the application and/or the service.

The buffered streaming traffic descriptor 362 may have a corresponding eleventh value 372 that can be utilized to indicate the buffered streaming traffic descriptor 362. The UE may provide the eleventh value 372 in a communication that can indicate that the traffic associated with the communication is to be routed in accordance with the buffered streaming traffic descriptor 362. In the illustrated embodiment, the eleventh value 372 is ‘11110110’, although it should be understood that the eleventh value 372 may be different in other embodiments.

The buffered streaming traffic descriptor 362 may have corresponding attributes 374 for the traffic related to the buffered streaming traffic descriptor 362, where the routing of the traffic may be performed to achieve the attributes 374. For example, the attributes 374 may include a priority indication, a packet delay indication, a packet error rate indication, a burst volume indication, an averaging window indication, or some combination thereof. In the illustrated embodiments, the attributes 374 for the buffered streaming traffic descriptor 362 are shown as a priority value of 80, a packet delay value of 300 ms, a packet error rate value of 0.00001, and an averaging window of 2000 ms. In this embodiment, the burst volume is not applicable. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the buffered streaming traffic descriptor 362 to meet these attribute values.

The HD streaming traffic descriptor 364 may be utilized for applications related to HD streaming of videos. For example, a UE may determine that an application being executed by the UE and/or a service being provided by the UE is related to HD streaming of videos. Based on the determination that the application and/or the service is related to HD streaming of videos, the UE may determine that the HD streaming traffic descriptor 364 is to be utilized for indicating the routing of traffic for the application and/or the service.

The HD streaming traffic descriptor 364 may have a corresponding twelfth value 376 that can be utilized to indicate the HD streaming traffic descriptor 364. The UE may provide the twelfth value 376 in a communication that can indicate that the traffic associated with the communication is to be routed in accordance with the HD streaming traffic descriptor 364. In the illustrated embodiment, the twelfth value 376 is ‘11110111’, although it should be understood that the twelfth value 376 may be different in other embodiments.

The HD streaming traffic descriptor 364 may have corresponding attributes 378 for the traffic related to the HD streaming traffic descriptor 364, where the routing of the traffic may be performed to achieve the attributes 378. For example, the attributes 378 may include a priority indication, a packet delay indication, a packet error rate indication, a burst volume indication, an averaging window indication, or some combination thereof. In the illustrated embodiments, the attributes 378 for the HD streaming traffic descriptor 364 are shown as a priority value of 25, a packet delay value of 100 ms, a packet error rate value of 0.0001, a burst volume of 1K and an averaging window of 2000 ms. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the HD streaming traffic descriptor 364 to meet these attribute values.

The 4K streaming traffic descriptor 366 may be utilized for applications related to 4K streaming of videos. For example, a UE may determine that an application being executed by the UE and/or a service being provided by the UE is related to 4K streaming of videos. Based on the determination that the application and/or the service is related to 4K streaming of videos, the UE may determine that the 4K streaming traffic descriptor 366 is to be utilized for indicating the routing of traffic for the application and/or the service.

The 4K streaming traffic descriptor 366 may have a corresponding thirteenth value 380 that can be utilized to indicate the 4K streaming traffic descriptor 366. The UE may provide the thirteenth value 380 in a communication that can indicate that the traffic associated with the communication is to be routed in accordance with the 4K streaming traffic descriptor 366. In the illustrated embodiment, the thirteenth value 380 is ‘11111000’, although it should be understood that the thirteenth value 380 may be different in other embodiments.

The 4K streaming traffic descriptor 366 may have corresponding attributes 382 for the traffic related to the 4K streaming traffic descriptor 366, where the routing of the traffic may be performed to achieve the attributes 382. For example, the attributes 382 may include a priority indication, a packet delay indication, a packet error rate indication, a burst volume indication, an averaging window indication, or some combination thereof. In the illustrated embodiments, the attributes 382 for the 4K streaming traffic descriptor 366 are shown as a priority value of 25, a packet delay value of 20 ms, a packet error rate value of 0.0001, a burst volume of 6K and an averaging window of 2000 ms. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the 4K streaming traffic descriptor 366 to meet these attribute values.

The traffic descriptors 302 may include an MNO specific traffic descriptor 384. The MNO specific traffic descriptor 384 may be defined by an MNO. For example, the MNO may define for which traffic the MNO specific traffic descriptor 384 is to be utilized, attributes for the MNO specific traffic descriptor 384, and/or the route for traffic associated with the MNO specific traffic descriptor 384. A UE may utilize the definitions from the MNO to determine for which traffic the MNO specific traffic descriptor 384 is to be utilized for indicating the routing of the traffic.

The MNO specific traffic descriptor 384 may have a corresponding fourteenth value 386 that can be utilized to indicate the MNO specific traffic descriptor 384. The UE may provide the fourteenth value 386 in a communication that can indicate that the traffic associated with the communication is to be routed in accordance with the MNO specific traffic descriptor 384. In the illustrated embodiment, the fourteenth value 386 is ‘11100000’, although it should be understood that the fourteenth value 386 may be different in other embodiments.

The traffic descriptors 302 may include an optimal QoS request traffic descriptor 388, which may be referred to as a best QoS traffic descriptor. The optimal QoS request traffic descriptor 388 may indicate a request that a highest-ranked, or highest-ranked based on indicated one or more attributes for the optimal QoS request traffic descriptor 388, routing be utilized for the traffic. For example, the optimal QoS request traffic descriptor 388 may be defined in some embodiments to request routing to achieve a lowest latency. Based on detecting the optimal QoS request traffic descriptor 388, a network device (which may include a base station (such as a nodeB, an enhanced nodeB (eNB), or a next generation nodeB (gNB)), a core network, or some combination thereof) may determine a routing that provides a lowest latency and route the traffic associated with the optimal QoS request traffic descriptor 388 according to the routing that provides the lowest latency. In some embodiments, the attributes associated with the optimal QoS request traffic descriptor 388 may be weighted, where the network device may determine a routing with a highest score based on the weighting of the attributes and utilize the routing for traffic associated with the optimal QoS request traffic descriptor 388.

The optimal QoS request traffic descriptor 388 may have a corresponding fifteenth value 390 that can be utilized to indicate the optimal QoS request traffic descriptor 388. The UE may provide the fifteenth value 390 in a communication that can indicate that the traffic associated with the communication is to be routed in accordance with the optimal QoS request traffic descriptor 388. In the illustrated embodiment, the fifteenth value 390 is ‘11100001’, although it should be understood that the fifteenth value 390 may be different in other embodiments.

The table 300 includes values that are defined for traffic descriptors. There are other values that may be undefined for traffic descriptors. All other values may be spare. If the other values are received, the other values may be interpreted as unknown.

Example values of FIG. 3 may be from Table 5.7.4-1 Standardized 5QI to QoS characteristics mapping—TS 23.501 (TS 23.501 “3^{rd} Generation Partnership Project; Technical Specification Group Services and System Aspects; System architecture for the 5G System (5GS); Stage 2 (Release 17).” 3GPP Organization Partners, March 2022.)

UE Policy Enhancement—URSP Traffic Descriptors for New Traffic Categories

Further additional traffic descriptors may be defined for use in the structure illustrated by the table 100 (FIG. 1) in the traffic category descriptors element 128 (FIG. 1). In some of these embodiments, the additional traffic descriptors may be based on QoS attributes and/or traffic characteristics. For example, the traffic descriptor for traffic of a UE may be based on QoS attributes targeted for the traffic. A UE may provide a communication with the traffic category descriptors element 128 being set to the value of one of the additional traffic descriptors, where the traffic of the UE corresponding to the communication may be routed based on value of the additional traffic descriptor.

FIG. 4 illustrates a table 400 of example traffic descriptors 402 in accordance with some embodiments. The traffic descriptors 402 may be used for the traffic category descriptors element 128 (FIG. 1). In particular, a value of a determined traffic descriptor from the traffic descriptors 402 may be included in the traffic category descriptors element 128 of a communication from a UE, where the traffic descriptor may be utilized for determining routing of traffic related to the communication.

The table 400 illustrates the traffic descriptors 402 with corresponding values 404. In particular, the values 404 may be utilized in the traffic category descriptor element 128 to indicate the corresponding traffic descriptors 402. As shown in the illustrated in the table 400, the values 404 may be an eight bit value in some embodiments. A UE may determine a traffic descriptor of the traffic descriptors 402 for traffic based on QoS attributes targeted for the traffic, an MNO specification defined for the traffic, or some combination thereof. The UE may provide a communication with the value of the values 404 corresponding to the determined traffic descriptor to indicate routing for the traffic.

The traffic descriptors 402 may include a match-all type traffic descriptor 406 and/or an OS Id+OS App ID type traffic descriptor 408. The match-all type traffic descriptor 406 may be equivalent to the match-all type traffic descriptor 206 (FIG. 2) in the traffic descriptors 202 (FIG. 2). The match-all type traffic descriptor 406 may correspond to a first value 410, the first value 410 being equal to ‘00000001’. The OS Id+OS App ID type traffic descriptor 408 may be equivalent to an OS Id+OS App ID type traffic descriptor in the traffic descriptors 202 (FIG. 2). The OS Id+OS App ID type traffic descriptor 408 may correspond to a second value 412, the second value 412 being equal to ‘00001000’.

Some of the traffic descriptors 402 may by QoS attribute traffic descriptors in the table 400. For example, each of these traffic descriptors in the portion of the traffic descriptors 402 may correspond to target QoS attribute value, where the traffic descriptor to be utilized for the routing may be determined based on a target QoS attributes for the traffic. A user, developer, MNO, or some combination thereof may define target QoS attributes for UE traffic. For example, the user, developer, and/or MNO may define the target attributes for operations being performed by the UE that generates the traffic.

The traffic descriptors 402 may include a first low latency, high bandwidth traffic descriptor 414. The first low latency, high bandwidth traffic descriptor 414 may be utilized for traffic with target attributes of low latency and/or high bandwidth. In some embodiments, a UE may determine that the traffic may have target attributes of low latency and/or high bandwidth, and the UE may determine that the first low latency, high bandwidth traffic descriptor 414 is to be utilized for the traffic based on the target attributes of low latency and/or high bandwidth. In some embodiments, the UE may determine that the traffic, or an operation associated with the traffic, has been defined to utilize the first low latency, high bandwidth traffic descriptor 414.

The first low latency, high bandwidth traffic descriptor 414 may have a corresponding third value 416 that can be utilized to indicate the first low latency, high bandwidth traffic descriptor 414. The UE may provide the third value 416 in a communication that can indicate that the traffic associated with the communication is to be routed in accordance with the first low latency, high bandwidth traffic descriptor 414. In the illustrated embodiment, the third value 416 is ‘11111001’, although it should be understood that the third value 416 may be different in other embodiments.

The first low latency, high bandwidth traffic descriptor 414 may have corresponding attributes 418 for the traffic related to the first low latency, high bandwidth traffic descriptor 414, where the routing of the traffic may be performed to achieve the attributes 418. For example, the attributes 418 may include a priority indication, a packet delay indication, a packet error rate indication, a burst volume indication, an averaging window indication, or some combination thereof. In the illustrated embodiments, the attributes 418 for the first low latency, high bandwidth traffic descriptor 414 may have a priority of latency, in particular low latency. The attributes 418 are shown as a packet delay value of 10-50 ms, a packet error rate value of 0.01, a burst volume of 6K, and an averaging window of 2000 ms. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the first low latency, high bandwidth traffic descriptor 414 to meet these attribute values and to have a low latency.

The traffic descriptors 402 may include a second low latency, high bandwidth traffic descriptor 420. The second low latency, high bandwidth traffic descriptor 420 may be utilized for traffic with target attributes of low latency and/or high bandwidth. In some embodiments, a UE may determine that the traffic may have target attributes of low latency and/or high bandwidth, and the UE may determine that the second low latency, high bandwidth traffic descriptor 420 is to be utilized for the traffic based on the target attributes of low latency and/or high bandwidth. In some embodiments, the UE may determine that the traffic, or an operation associated with the traffic, has been defined to utilize the second low latency, high bandwidth traffic descriptor 420.

The second low latency, high bandwidth traffic descriptor 420 may have a corresponding fourth value 422 that can be utilized to indicate the second low latency, high bandwidth traffic descriptor 420. The UE may provide the fourth value 422 in a communication that can indicate that the traffic associated with the communication is to be routed in accordance with the second low latency, high bandwidth traffic descriptor 420. In the illustrated embodiment, the fourth value 422 is ‘11111010’, although it should be understood that the fourth value 422 may be different in other embodiments.

The second low latency, high bandwidth traffic descriptor 420 may have corresponding attributes 424 for the traffic related to the second low latency, high bandwidth traffic descriptor 420, where the routing of the traffic may be performed to achieve the attributes 424. For example, the attributes 424 may include a priority indication, a packet delay indication, a packet error rate indication, a burst volume indication, an averaging window indication, or some combination thereof. In the illustrated embodiments, the attributes 424 for the second low latency, high bandwidth traffic descriptor 420 may have a priority of bandwidth, in particular high bandwidth. The attributes 424 are shown as a packet delay value of 10-50 ms, a packet error rate value of 0.01, a burst volume of 6K, and an averaging window of 2000 ms. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the second low latency, high bandwidth traffic descriptor 420 to meet these attribute values and to have a low latency.

The traffic descriptors 402 may include a first low latency, low packet error rate traffic descriptor 426. The first low latency, low packet error rate traffic descriptor 426 may be utilized for traffic with target attributes of low latency and/or low packet error rate. In some embodiments, a UE may determine that the traffic may have target attributes of low latency and/or low packet error rate, and the UE may determine that the first low latency, low packet error rate traffic descriptor 426 is to be utilized for the traffic based on the target attributes of low latency and/or low packet error rate. In some embodiments, the UE may determine that the traffic, or an operation associated with the traffic, has been defined to utilize the first low latency, low packet error rate traffic descriptor 426.

The first low latency, low packet error rate traffic descriptor 426 may have a corresponding fifth value 428 that can be utilized to indicate the first low latency, low packet error rate traffic descriptor 426. The UE may provide the fifth value 428 in a communication that can indicate that the traffic associated with the communication is to be routed in accordance with the first low latency, low packet error rate traffic descriptor 426. In the illustrated embodiment, the fifth value 428 is ‘11111011’, although it should be understood that the fifth value 428 may be different in other embodiments.

The first low latency, low packet error rate traffic descriptor 426 may have corresponding attributes 430 for the traffic related to the first low latency, low packet error rate traffic descriptor 426, where the routing of the traffic may be performed to achieve the attributes 430. For example, the attributes 430 may include a priority indication, a packet delay indication, a packet error rate indication, a burst volume indication, an averaging window indication, or some combination thereof. In the illustrated embodiments, the attributes 430 for the first low latency, low packet error rate traffic descriptor 426 may have a priority of latency, in particular low latency. The attributes 430 are shown as a packet delay value of 10-50 ms, a packet error rate value of 0.00001, and an averaging window of 2000 ms. In this embodiment, the burst volume may not be applicable. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the first low latency, low packet error rate traffic descriptor 426 to meet these attribute values and to have a low packet error rate.

The traffic descriptors 402 may include a second low latency, low packet error rate traffic descriptor 432. The second low latency, low packet error rate traffic descriptor 432 may be utilized for traffic with target attributes of low latency and/or low packet error rate. In some embodiments, a UE may determine that the traffic may have target attributes of low latency and/or low packet error rate, and the UE may determine that the second low latency, low packet error rate traffic descriptor 432 is to be utilized for the traffic based on the target attributes of low latency and/or low packet error rate. In some embodiments, the UE may determine that the traffic, or an operation associated with the traffic, has been defined to utilize the second low latency, low packet error rate traffic descriptor 432.

The second low latency, low packet error rate traffic descriptor 432 may have a corresponding sixth value 434 that can be utilized to indicate the second low latency, low packet error rate traffic descriptor 432. The UE may provide the sixth value 434 in a communication that can indicate that the traffic associated with the communication is to be routed in accordance with the second low latency, low packet error rate traffic descriptor 432. In the illustrated embodiment, the sixth value 434 is ‘11111100’, although it should be understood that the sixth value 434 may be different in other embodiments.

The second low latency, low packet error rate traffic descriptor 432 may have corresponding attributes 436 for the traffic related to the second low latency, low packet error rate traffic descriptor 432, where the routing of the traffic may be performed to achieve the attributes 436. For example, the attributes 436 may include a priority indication, a packet delay indication, a packet error rate indication, a burst volume indication, an averaging window indication, or some combination thereof. In the illustrated embodiments, the attributes 436 for the second low latency, low packet error rate traffic descriptor 432 may have a priority of packet error rate, in particular low packet error rate. The attributes 436 are shown as a packet delay value of 10-50 ms, a packet error rate value of 0.00001, and an averaging window of 2000 ms. In this embodiment, the burst volume may not be applicable. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the second low latency, low packet error rate traffic descriptor 432 to meet these attribute values and to have a low packet error rate.

The traffic descriptors 402 may include a first high bandwidth, low packet error rate traffic descriptor 438. The first high bandwidth, low packet error rate traffic descriptor 438 may be utilized for traffic with target attributes of high bandwidth and/or low packet error rate. In some embodiments, a UE may determine that the traffic may have target attributes of high bandwidth and/or low packet error rate, and the UE may determine that the first high bandwidth, low packet error rate traffic descriptor 438 is to be utilized for the traffic based on the target attributes of high bandwidth and/or low packet error rate. In some embodiments, the UE may determine that the traffic, or an operation associated with the traffic, has been defined to utilize the first high bandwidth, low packet error rate traffic descriptor 438.

The first high bandwidth, low packet error rate traffic descriptor 438 may have a corresponding seventh value 440 that can be utilized to indicate the first high bandwidth, low packet error rate traffic descriptor 438. The UE may provide the seventh value 440 in a communication that can indicate that the traffic associated with the communication is to be routed in accordance with the first high bandwidth, low packet error rate traffic descriptor 438. In the illustrated embodiment, the seventh value 440 is ‘11110001’, although it should be understood that the seventh value 440 may be different in other embodiments.

The first high bandwidth, low packet error rate traffic descriptor 438 may have corresponding attributes 442 for the traffic related to the first high bandwidth, low packet error rate traffic descriptor 438, where the routing of the traffic may be performed to achieve the attributes 442. For example, the attributes 442 may include a priority indication, a packet delay indication, a packet error rate indication, a burst volume indication, an averaging window indication, or some combination thereof. In the illustrated embodiments, the attributes 442 for the first high bandwidth, low packet error rate traffic descriptor 438 may have a priority of bandwidth, in particular high bandwidth. The attributes 442 are shown as a packet delay value of 300-500 ms, a packet error rate value of 0.00001, a burst volume of 3K-6K, and an averaging window of 2000 ms. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the first high bandwidth, low packet error rate traffic descriptor 438 to meet these attribute values and to have a high bandwidth.

The traffic descriptors 402 may include a second high bandwidth, low packet error rate traffic descriptor 444. The second high bandwidth, low packet error rate traffic descriptor 444 may be utilized for traffic with target attributes of high bandwidth and/or low packet error rate. In some embodiments, a UE may determine that the traffic may have target attributes of high bandwidth and/or low packet error rate, and the UE may determine that the second high bandwidth, low packet error rate traffic descriptor 444 is to be utilized for the traffic based on the target attributes of high bandwidth and/or low packet error rate. In some embodiments, the UE may determine that the traffic, or an operation associated with the traffic, has been defined to utilize the second high bandwidth, low packet error rate traffic descriptor 444.

The second high bandwidth, low packet error rate traffic descriptor 444 may have a corresponding eighth value 446 that can be utilized to indicate the second high bandwidth, low packet error rate traffic descriptor 444. The UE may provide the eighth value 446 in a communication that can indicate that the traffic associated with the communication is to be routed in accordance with the second high bandwidth, low packet error rate traffic descriptor 444. In the illustrated embodiment, the eighth value 446 is ‘11110010’, although it should be understood that the eighth value 446 may be different in other embodiments.

The second high bandwidth, low packet error rate traffic descriptor 444 may have corresponding attributes 448 for the traffic related to the second high bandwidth, low packet error rate traffic descriptor 444, where the routing of the traffic may be performed to achieve the attributes 448. For example, the attributes 448 may include a priority indication, a packet delay indication, a packet error rate indication, a burst volume indication, an averaging window indication, or some combination thereof. In the illustrated embodiments, the attributes 448 for the second high bandwidth, low packet error rate traffic descriptor 444 may have a priority of packet error rate, in particular low packet error rate. The attributes 448 are shown as a packet delay value of 300-500 ms, a packet error rate value of 0.00001, a burst volume of 3K-6K, and an averaging window of 2000 ms. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the second high bandwidth, low packet error rate traffic descriptor 444 to meet these attribute values and to have a low packet error rate.

The traffic descriptors 402 may include a first low latency, low bandwidth, low packet error rate traffic descriptor 450. The first low latency, low bandwidth, low packet error rate traffic descriptor 450 may be utilized for traffic with target attributes of low latency, low bandwidth, and/or low packet error rate. In some embodiments, a UE may determine that the traffic may have target attributes of low latency, low bandwidth, and/or low packet error rate, and the UE may determine that the first low latency, low bandwidth, low packet error rate traffic descriptor 450 is to be utilized for the traffic based on the target attributes of low latency, low bandwidth, and/or low packet error rate. In some embodiments, the UE may determine that the traffic, or an operation associated with the traffic, has been defined to utilize the first low latency, low bandwidth, low packet error rate traffic descriptor 450.

The first low latency, low bandwidth, low packet error rate traffic descriptor 450 may have a corresponding ninth value 452 that can be utilized to indicate the first low latency, low bandwidth, low packet error rate traffic descriptor 450. The UE may provide the ninth value 452 in a communication that can indicate that the traffic associated with the communication is to be routed in accordance with the first low latency, low bandwidth, low packet error rate traffic descriptor 450. In the illustrated embodiment, the ninth value 452 is ‘11110101’, although it should be understood that the ninth value 452 may be different in other embodiments.

The first low latency, low bandwidth, low packet error rate traffic descriptor 450 may have corresponding attributes 454 for the traffic related to the first low latency, low bandwidth, low packet error rate traffic descriptor 450, where the routing of the traffic may be performed to achieve the attributes 454. For example, the attributes 454 may include a priority indication, a packet delay indication, a packet error rate indication, a burst volume indication, an averaging window indication, or some combination thereof. In the illustrated embodiments, the attributes 454 for the first low latency, low bandwidth, low packet error rate traffic descriptor 450 may have a priority of latency and packet error rate, in particular low latency and low packet error rate. The attributes 454 are shown as a packet delay value of 10-50 ms, a packet error rate value of 0.0000001, a burst volume of 255, and an averaging window of 2000 ms. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the first low latency, low bandwidth, low packet error rate traffic descriptor 450 to meet these attribute values, and to have a low latency and a low packet error rate.

The traffic descriptors 402 may include a second low latency, low bandwidth, low packet error rate traffic descriptor 456. The second low latency, low bandwidth, low packet error rate traffic descriptor 456 may be utilized for traffic with target attributes of low latency, low bandwidth, and/or low packet error rate. In some embodiments, a UE may determine that the traffic may have target attributes of low latency, low bandwidth, and/or low packet error rate, and the UE may determine that the second low latency, low bandwidth, low packet error rate traffic descriptor 456 is to be utilized for the traffic based on the target attributes of low latency, low bandwidth, and/or low packet error rate. In some embodiments, the UE may determine that the traffic, or an operation associated with the traffic, has been defined to utilize the second low latency, low bandwidth, low packet error rate traffic descriptor 456.

The second low latency, low bandwidth, low packet error rate traffic descriptor 456 may have a corresponding tenth value 458 that can be utilized to indicate the second low latency, low bandwidth, low packet error rate traffic descriptor 456. The UE may provide the tenth value 458 in a communication that can indicate that the traffic associated with the communication is to be routed in accordance with the second low latency, low bandwidth, low packet error rate traffic descriptor 456. In the illustrated embodiment, the tenth value 458 is ‘11110110’, although it should be understood that the tenth value 458 may be different in other embodiments.

The second low latency, low bandwidth, low packet error rate traffic descriptor 456 may have corresponding attributes 460 for the traffic related to the second low latency, low bandwidth, low packet error rate traffic descriptor 456, where the routing of the traffic may be performed to achieve the attributes 460. For example, the attributes 460 may include a priority indication, a packet delay indication, a packet error rate indication, a burst volume indication, an averaging window indication, or some combination thereof. In the illustrated embodiments, the attributes 460 for the second low latency, low bandwidth, low packet error rate traffic descriptor 456 may have a priority of bandwidth and packet error rate, in particular low bandwidth and low packet error rate. The attributes 460 are shown as a packet delay value of 10-50 ms, a packet error rate value of 0.0000001, a burst volume of 255, and an averaging window of 2000 ms. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the second low latency, low bandwidth, low packet error rate traffic descriptor 456 to meet these attribute values, and to have a low bandwidth and a low packet error rate.

The traffic descriptors 402 may include a third low latency, low bandwidth, low packet error rate traffic descriptor 462. The third low latency, low bandwidth, low packet error rate traffic descriptor 462 may be utilized for traffic with target attributes of low latency, low bandwidth, and/or low packet error rate. In some embodiments, a UE may determine that the traffic may have target attributes of low latency, low bandwidth, and/or low packet error rate, and the UE may determine that the third low latency, low bandwidth, low packet error rate traffic descriptor 462 is to be utilized for the traffic based on the target attributes of low latency, low bandwidth, and/or low packet error rate. In some embodiments, the UE may determine that the traffic, or an operation associated with the traffic, has been defined to utilize the third low latency, low bandwidth, low packet error rate traffic descriptor 462.

The third low latency, low bandwidth, low packet error rate traffic descriptor 462 may have a corresponding eleventh value 464 that can be utilized to indicate the third low latency, low bandwidth, low packet error rate traffic descriptor 462. The UE may provide the eleventh value 464 in a communication that can indicate that the traffic associated with the communication is to be routed in accordance with the third low latency, low bandwidth, low packet error rate traffic descriptor 462. In the illustrated embodiment, the eleventh value 464 is ‘11110111’, although it should be understood that the eleventh value 464 may be different in other embodiments.

The third low latency, low bandwidth, low packet error rate traffic descriptor 462 may have corresponding attributes 466 for the traffic related to the third low latency, low bandwidth, low packet error rate traffic descriptor 462, where the routing of the traffic may be performed to achieve the attributes 466. For example, the attributes 466 may include a priority indication, a packet delay indication, a packet error rate indication, a burst volume indication, an averaging window indication, or some combination thereof. In the illustrated embodiments, the attributes 466 for the third low latency, low bandwidth, low packet error rate traffic descriptor 462 may have a priority of latency and bandwidth, in particular low latency and low bandwidth. The attributes 466 are shown as a packet delay value of 10-50 ms, a packet error rate value of 0.0000001, a burst volume of 255, and an averaging window of 2000 ms. It should be understood in other embodiments, these attributes may be defined with different values. A network device (which may include a base station (such as a nodeB, an enhanced nodeB (eNB), or a next generation nodeB (gNB)), a core network, or some combination thereof) may route traffic associated with the third low latency, low bandwidth, low packet error rate traffic descriptor 462 to meet these attribute values, and to have a low latency and a low bandwidth.

The traffic descriptors 402 may include an MNO specific traffic descriptor 468. The MNO specific traffic descriptor 468 may be defined by an MNO. For example, the MNO may define for which traffic the MNO specific traffic descriptor 468 is to be utilized, attributes for the MNO specific traffic descriptor 468, and/or the route for traffic associated with the MNO specific traffic descriptor 468. A UE may utilize the definitions from the MNO to determine for which traffic the MNO specific traffic descriptor 468 is to be utilized for indicating the routing of the traffic.

The MNO specific traffic descriptor 468 may have a corresponding twelfth value 470 that can be utilized to indicate the MNO specific traffic descriptor 468. The UE may provide the twelfth value 470 in a communication that can indicate that the traffic associated with the communication is to be routed in accordance with the MNO specific traffic descriptor 468. In the illustrated embodiment, the twelfth value 470 is ‘11100000’, although it should be understood that the twelfth value 470 may be different in other embodiments.

The traffic descriptors 402 may include an optimal QoS request traffic descriptor 472, which may be referred to as a best QoS traffic descriptor. The optimal QoS request traffic descriptor 472 may indicate a request that a highest-ranked, or highest-ranked based on indicated one or more attributes for the optimal QoS request traffic descriptor 472, routing be utilized for the traffic. For example, the optimal QoS request traffic descriptor 472 may be defined in some embodiments to request routing to achieve a lowest latency. Based on detecting the optimal QoS request traffic descriptor 472, a network device (which may include a base station (such as a nodeB, an enhanced nodeB (eNB), or a next generation nodeB (gNB)), a core network, or some combination thereof) may determine a routing that provides a lowest latency and route the traffic associated with the optimal QoS request traffic descriptor 472 according to the routing that provides the lowest latency. In some embodiments, the attributes associated with the optimal QoS request traffic descriptor 472 may be weighted, where the network device may determine a routing with a highest score based on the weighting of the attributes and utilize the routing for traffic associated with the optimal QoS request traffic descriptor 472.

The optimal QoS request traffic descriptor 472 may have a corresponding thirteenth value 474 that can be utilized to indicate the optimal QoS request traffic descriptor 472. The UE may provide the thirteenth value 474 in a communication that can indicate that the traffic associated with the communication is to be routed in accordance with the optimal QoS request traffic descriptor 472. In the illustrated embodiment, the thirteenth value 474 is ‘11100001’, although it should be understood that the thirteenth value 474 may be different in other embodiments.

The table 400 includes values that are defined for traffic descriptors. There are other values that may be undefined for traffic descriptors. All other values may be spare. If the other values are received, the other values may be interpreted as unknown. Example values of FIG. 4 may be from Table 5.7.4-1 Standardized 5QI to QoS characteristics mapping—TS 23.501.

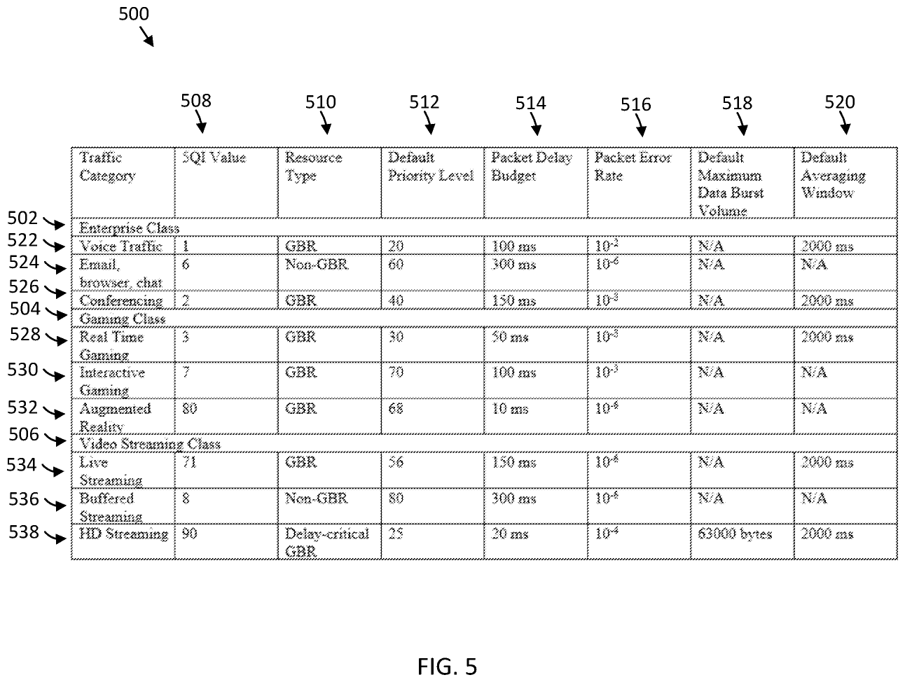

FIG. 5 illustrates a table 500 of example traffic descriptors in accordance with some embodiments. The traffic descriptors may be used for the traffic category descriptors element 128 (FIG. 1). In particular, a value of a determined traffic descriptor from the traffic descriptors may be included in the traffic category descriptors element 128 of a communication from a UE, where the traffic descriptor may be utilized for determining routing of traffic related to the communication.

Traffic categories can be defined based on type of service (e.g., enterprise class services, gaming services, video streaming services, etc.) handled by an application which can then map to a range of values for a set of QoS attributes that define these services adequately. As an example, voice traffic may have a 5G QoS identifier (5QI) value of 1, may use guaranteed bit rate (GBR) resources, have default priority level of 20, may have packet delay of 100 ms, packet error rate of 10-2 and averaging window of 2000 ms.

Another way to characterize traffic categories can be based on just the traffic characteristics and QoS attributes. The specific QoS attributes could have a relative priority level (e.g., low latency, high bandwidth slice with latency as higher priority). Priority can be given to single or multiple QoS attributes depending on traffic category.

It may be a little easier to define traffic categories based on traffic characteristics as a limited set of traffic characteristics could cover a large number of applications and services whereas it may be difficult to cover all services or application types. Defining traffic categories based on traffic characteristics also alleviates privacy concerns as for example, a “low priority, low bandwidth, normal/high latency data connection” may reveal much less information about user, than say for example “use of social media”. It may also be more meaningful to associate traffic characteristics to different flows than say service types. As an example, a gaming application may have multiple flows active at any given time but only a few of them may be carrying low latency traffic. A slice that is configured for handling “low latency” traffic for any gaming application could be much more useful in improving user experience as compared to when all active flows are mapped on to a “gaming” slice.

The 5G QoS characteristics describe the edge-to-edge packet treatment received by a QoS flow between the UE and UPF in terms of various performance characteristics. These performance characteristics include Resource type (GBR, non-GBR), Priority level, Packet delay budget, Packet error rate, Averaging window, Maximum data burst volume, etc. Standardized 5QI values are specified for services that are frequently used and the one-to-one mapping between standardized 5QI values and the 5G QoS performance characteristics.

Traffic categories can be defined based on type of service handled by an application. As an example, enterprise class applications could include traffic categories for email, browsing, chat, conferencing, voice, etc. Similarly gaming applications could include real-time gaming, interactive gaming and other games which could include extended reality (XR) type of traffic as well. Similarly, video streaming class of applications could also include live or buffered streaming, HD streaming, 4K streaming traffic, etc. For each of these service types, the traffic categories can then be mapped to specific 5G QoS performance characteristics. In addition to different well known services, traffic categories can also be MNO specific or even have specific QoS attributes or parameters that may not map to a well-known services.

The table 500 illustrates a plurality of traffic descriptors. The traffic descriptors may be grouped based on services to which the traffic descriptors relate. In the illustrated embodiment in the table 500, the traffic descriptors are illustrated divided into an enterprise class 502, a gaming class 504, and a video streaming class 506. The enterprise class 502 may relate to services provided by an enterprise. The gaming class 504 may relate to services associated with gaming. The video streaming class 506 may relate to services associated with video streaming.

Each of the traffic descriptors may correspond to a 5QI value 508. Further, each of the traffic descriptors may be defined by one or more QoS attributes, such as a resource type 510, a default priority level 512, a packet delay budget 514, a packet error rate 516, a default maximum data burst volume 518, and/or a default averaging window 520. For example, the enterprise class 502 may include a voice traffic descriptor 522. The voice traffic descriptor 522 may correspond to a 5QI value 508 of 1. Further, the voice traffic descriptor 522 may have specified QoS attributes of a resource type 510 of GBR, a default priority level 512 of 20, a packet delay budget 514 of 100 ms, a packet error rate 516 of 10⁻², a default maximum data burst volume 518 that is not applicable (N/A), and a default averaging window of 2000 ms. 5 QI values and QoS attributes for the other traffic descriptors are indicated accordingly in the table 500.

The enterprise class 502 may include one or more traffic descriptors to be utilized for enterprise services. For example, the enterprise class 502 includes the voice traffic descriptor 522, an email, browser, chat traffic descriptor 524, and a conferencing traffic descriptor 526 in the illustrated embodiment. It is to be understood that the enterprise class 502 may include different traffic descriptors in other embodiments.

The gaming class 504 may include one or more traffic descriptors to be utilized for enterprise services. For example, the gaming class 504 includes a real time gaming traffic descriptor 528, an interactive gaming traffic descriptor 530, and an augmented reality traffic descriptor 532 in the illustrated embodiment. It is to be understood that the gaming class 504 may include different traffic descriptors in other embodiments.

The video streaming class 506 may include one or more traffic descriptors to be utilized for enterprise services. For example, the video streaming class 506 includes a live streaming traffic descriptor 534, a buffered streaming traffic descriptor 536, and an HD streaming traffic descriptor 538 in the illustrated embodiment. It is to be understood that the video streaming class 506 may include different traffic descriptors in other embodiments.

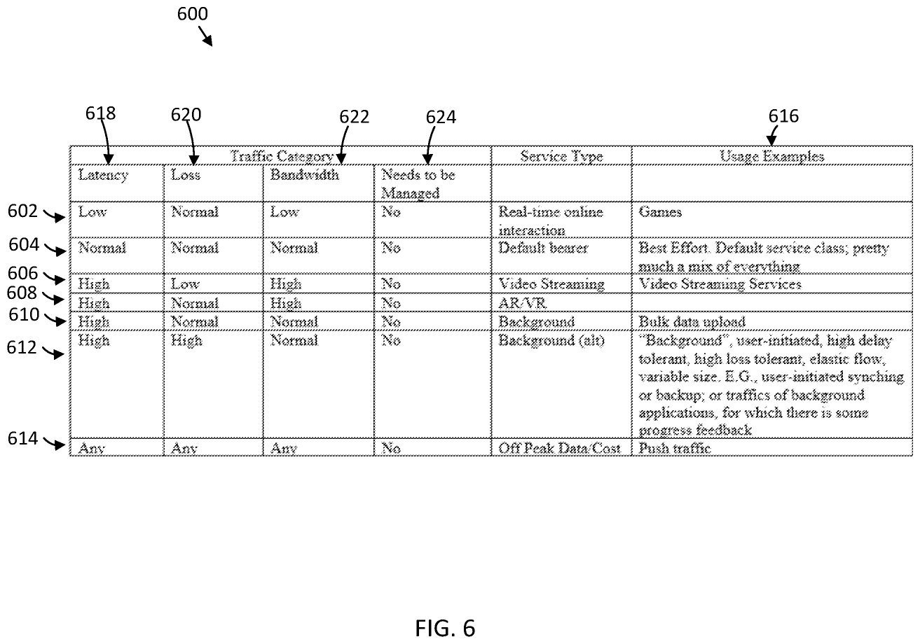

FIG. 6 illustrates a table 600 of example traffic descriptors in accordance with some embodiments. The traffic descriptors may be used for the traffic category descriptors element 128 (FIG. 1). In particular, a value of a determined traffic descriptor from the traffic descriptors may be included in the traffic category descriptors element 128 of a communication from a UE, where the traffic descriptor may be utilized for determining routing of traffic related to the communication.

Traffic categories can also be defined directly based on traffic characteristics and the specific QoS attributes could have a relative priority level. As an example, for a certain class of traffic, there could be relative priority among the QoS attributes latency and bandwidth (e.g., low latency and high bandwidth with latency as higher priority). Priority can be given to single or multiple QoS attributes (e.g., prioritize latency and packet error rate over bandwidth for voice traffic, prioritize latency and bandwidth over packet error rate for gaming or video streaming traffic, etc.).

The table 600 illustrates traffic descriptors that may be defined based traffic characteristics. Further, the traffic descriptors may be defined based on a service type. For example, the traffic descriptors include a real-time online interaction traffic descriptor 602, a default bearer traffic descriptor 604, a video streaming traffic descriptor 606, an augmented reality (AR)/virtual reality (VR) traffic descriptor 608, a background traffic descriptor 610, an alternative background traffic descriptor 612, and an off peak data/cost traffic descriptors 614. Each traffic descriptor may be utilized for certain operations, as indicated in usage examples 616. It should be understood that different traffic descriptors defined on traffic characteristics may be defined in other embodiments.

Each of the traffic descriptors may be defined based on QoS attributes. For example, the traffic descriptors may be defined by latency 618, loss 620, bandwidth 622, and whether the traffic needs, or is defined to be, managed 624 (which will be referred to as “needs to be managed” for clarity). Values for each of the QoS attributes may be defined based on a defined degree. For example, the QoS attributes may be defined with values of low, normal, or high. For latency 618, low may refer to an amount of latency less than a first value, normal may refer to an amount of latency greater than or equal to the first value and less than a second value, and high may refer to an amount of latency greater than or equal to the second value. For loss 620, low may refer to an amount of data loss less than a first value, normal may refer to an amount of data loss greater than or equal to the first value and less than a second value, and high may refer to an amount of data loss greater than or equal to the second value. For bandwidth 622, low may refer to an amount of bandwidth less than a first value, normal may refer to an amount of bandwidth greater than or equal to the first value and less than a second value, and high may refer to an amount of bandwidth greater than or equal to the second value.

In the illustrated example of the traffic descriptors in table 600, the real-time online interaction traffic descriptor 602 is defined with a latency 618 of low, a loss 620 of normal, and a bandwidth 622 of low. The default bearer traffic descriptor 604 is defined with a latency 618 of normal, a loss 620 of normal, and a bandwidth 622 of normal. The video streaming traffic descriptor 606 is defined with a latency 618 of high, a loss 620 of low, and a bandwidth 622 of high. The AR/VR traffic descriptor 608 is defined with a latency 618 of high, a loss 620 of normal, and a bandwidth 622 of high. The background traffic descriptor 610 is defined with a latency 618 of high, a loss 620 of normal, and a bandwidth 622 of normal. The alternative background traffic descriptor 612 is defined with a latency 618 of high, a loss 620 of high, and a bandwidth 622 of normal.

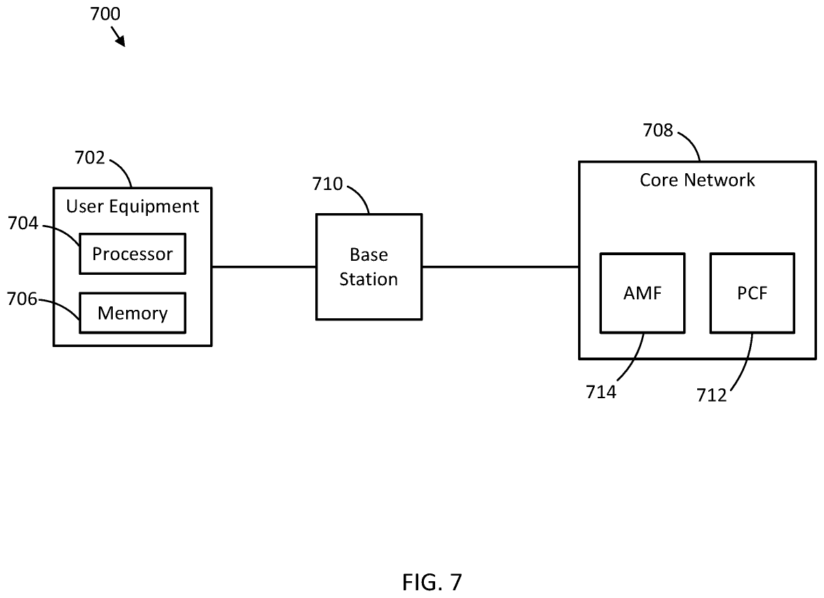

FIG. 7 illustrates an example system 700 in accordance with some embodiments. In particular, the system 700 may utilize one or more of the traffic descriptors described herein (such as the traffic descriptors 202 (FIG. 2), the traffic descriptors 302 (FIG. 3), the traffic descriptors 402 (FIG. 4), the traffic descriptors of table 500 (FIG. 5), and/or the traffic descriptors of table 600 (FIG. 6)) for the routing of traffic of a UE. For example, the system 700 may exchange communications having the structure described in relation to table 100 (FIG. 1) between elements of the system 700 that can allow the elements to indicate and perform routing of traffic for UEs.

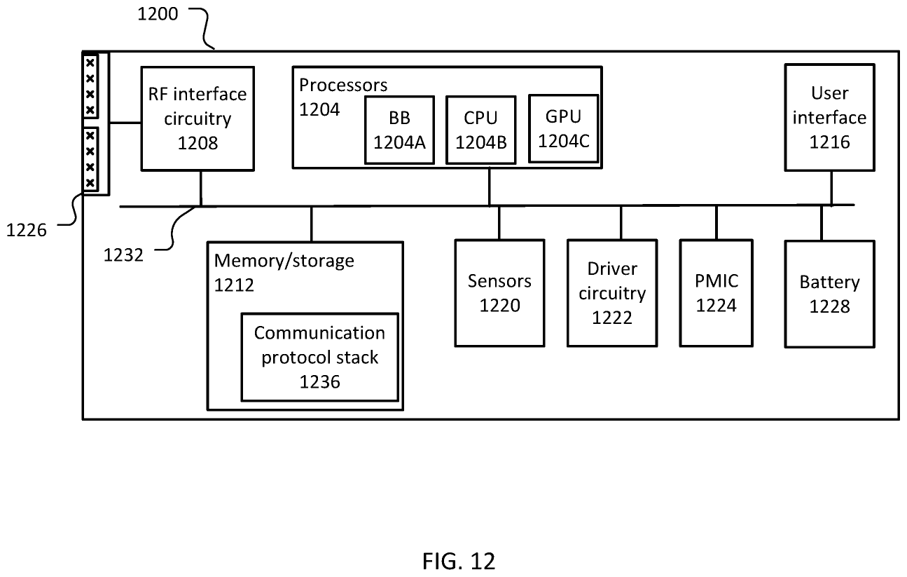

The system 700 may include one or more UEs, such as the UE 702. For clarity, operations of the UE 702 are described and it should be understood that one or more of the other UEs may perform the operations of the UE 702. The UE 702 may include one or more of the features of the UE 1200 (FIG. 12). The UE 702 may include memory 704 and one or more processors 706, the processors 706 being coupled to the memory 704. The memory 704 may store one or more instructions that, when executed by the processors 706, can cause the UE 702 to perform one or more operations.

The memory 704 of the UE 702 may store information related to the traffic descriptors. For example, the memory 704 may store the traffic descriptors (such as the traffic descriptors 202, the traffic descriptors 302, and/or the traffic descriptors 402), the values corresponding to the traffic descriptors (such as the values 204 (FIG. 2), the values 304 (FIG. 3), the values 404 (FIG. 4), and/or the 5QI values 508 (FIG. 5)), attributes corresponding to the traffic descriptors (such as the attributes described in relation to table 300 (FIG. 3), the attributes described in relation to table 400 (FIG. 4), the attributes described in relation to table 500 (FIG. 5), and/or the attributes described in relation to table 600 (FIG. 6)), or some combination thereof.

The UE 702 may execute one or more programs and/or operations that produce traffic (for example, communications) between the user equipment and one or more other elements of the system. The UE 702 may determine a traffic descriptor from the traffic descriptors for the traffic. For example, the processors 706 may access the traffic descriptors from the memory 704 and determine one of the traffic descriptors to be utilized for the traffic. The traffic descriptor to be utilized for the traffic may be determined based on an application associated with the traffic, a service associated with the traffic, target attributes for transmission of the traffic, or some combination thereof in embodiments. The UE 702 may generate a communication to be sent with the traffic or prior to transmission of the traffic, where the communication may indicate the traffic descriptor to be utilized for the traffic. In some embodiments, the indication of the traffic descriptor included in the application may be a value corresponding to the traffic descriptor (such as the values 204, the values 304, the values 404, and/or the 5QI values 508).

The system 700 may further include a core network 708. The core network 708 may provide one or more services for user equipment within the system 700, including the UE 702. The core network 708 may include one or more resources that provide the services to the user equipment. The core network 708 may route traffic among the resources of the core network 708 based on a traffic descriptor corresponding to the traffic. Further, the core network 708 may provide traffic descriptors (such as the traffic descriptors 202, the traffic descriptors 302, the traffic descriptors 402, the traffic descriptors of table 500, and/or the traffic descriptors of table 600) to the user equipment for storage in memory (such as the memory 704) and use for routing of the traffic. The traffic descriptors may be provided as part of one or more URSP rules, where the URSP may be provided in accordance with the structure illustrated in table 100.

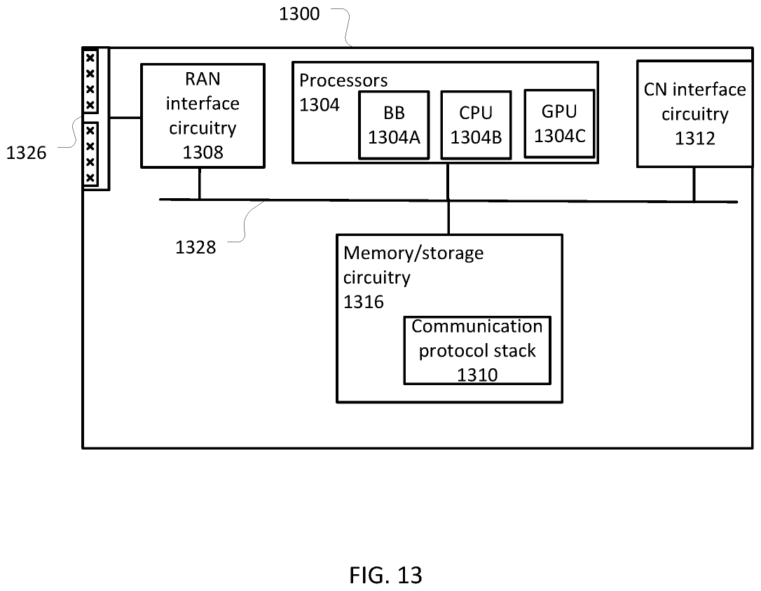

The system 700 may include a base station 710. The base station 710 may include one or more of the features of the gNB 1300 (FIG. 13). The base station 710 may provide wireless and/or wired connections to the UE 702 and/or the core network 708. For example, the base station 710 may facilitate communication between the UE 702 and the core network 708. In some embodiments, the base station 710 may further facilitate routing of traffic of the UE in accordance with a corresponding traffic descriptor.

The UE 702 may be configured with the traffic descriptors at the time of activation and/or production of the UE 702, may be configured with the traffic descriptors at a time after the activation and/or production of the UE 702, or some combination thereof. In instances where the UE 702 are configured with the traffic descriptors at the time of activation and/or production, the traffic descriptors may be stored in the memory 704 for utilization during operation.

In instances where the UE 702 may be configured with the traffic descriptors after activation and/or production of the UE 702, the core network 708 may provide the traffic descriptors to the UE 702 for storage in the memory 704 for utilization during operation. For example, the core network 708 may provide the traffic descriptors to the UE 702 during registration of the UE 702 with the core network 708, may push the traffic descriptors to the UE 702 any time after the UE 702 has registered with the core network 708, or some combination thereof. In some embodiments, a PCF 712 of the core network 708 may generate the traffic descriptors, and the PCF 712 may provide the traffic descriptors to an access and mobility management function (AMF) 714 of the core network 708 for provision to the UE 702.

The PCF 712 may store and/or generate traffic descriptors to be utilized for routing of traffic of a UE, such as the UE 702. In embodiments where the traffic descriptors are provided to the UE 702 during registration of the UE 702, the core network 708 may detect a registration message received from the UE 702 or another indication of registration of the UE 702. In response to the registration message or other indication, the PCF 712 and/or the AMF 714 may generate a communication having traffic descriptors, where the communication may have the structure described in relation to table 100 in some embodiments. In some embodiments, the communication may be a non-access stratum (NAS) message. The NAS message may further include URSP rules for determining which traffic descriptor is to be utilized for traffic. The AMF 714 may provide the communication with the traffic descriptors to the UE 702 via the base station 710 as part of the registration process. The UE 702 may store the traffic descriptors in the memory 704 to be utilized for indicating routing of traffic of the UE 702.

In other instances, the core network 708 may provide traffic descriptors to the UE 702 after the UE 702 has been registered with the core network 708. The core network 708 may provide the traffic descriptors, or some portion thereof, at set intervals, in response to updates to the traffic descriptors, and/or in response to other triggers. The PCF 712 and/or the AMF 714 may generate a communication having traffic descriptors, where the communication may have the structure described in relation to table 100 in some embodiments. In some embodiments, the communication with the traffic descriptors may be a NAS message. The NAS message may further include URSP rules for determining which traffic descriptor is to be utilized for traffic. The core network 708 may push the communication to the UE 702 via the base station 710 for storage in the memory 704.

The UE 702 may begin execution of an application and/or operation that generates traffic to be exchanged and/or processed by the core network 708. The UE 702 may determine a traffic descriptor to be utilized with the traffic to indicate the routing for the traffic. In embodiments, the UE 702 may determine the traffic descriptor to be utilized based on the application, the service being provided, target attributes for the traffic, or some combination. The UE 702 select the traffic descriptor for the traffic from the traffic descriptors stored in the memory 704. The UE 702 may generate a communication that indicates the traffic descriptor for the traffic, such as by including a corresponding value to the traffic descriptor. The UE 702 may transmit the communication at a start of, or prior to the start of, the traffic.

The core network 708 may detect the communication received from the UE 702 and identify the traffic descriptor from the communication. The core network 708 may determine a routing for associated traffic based on the traffic descriptor. The core network 708 may route the traffic associated with the traffic descriptor according to a routing corresponding to the traffic descriptor. For example, the core network 708 may direct the traffic to resources in core network that provide the service in accordance with the attributes corresponding to the traffic descriptor.

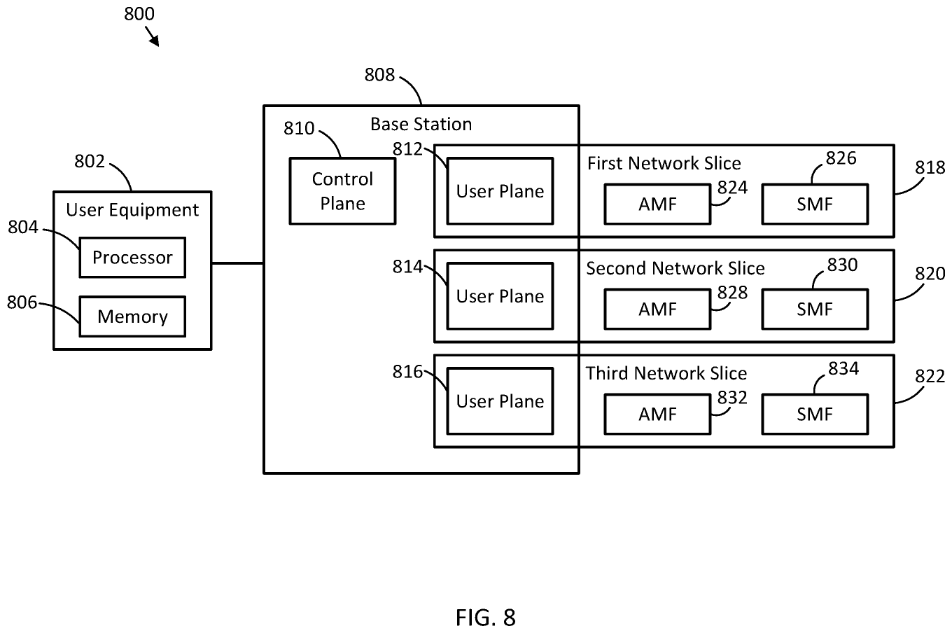

FIG. 8 illustrates another example system 800 in accordance with some embodiments. In particular, the system 800 may utilize one or more of the traffic descriptors described herein (such as the traffic descriptors 202 (FIG. 2), the traffic descriptors 302 (FIG. 3), the traffic descriptors 402 (FIG. 4), the traffic descriptors of table 500 (FIG. 5), and/or the traffic descriptors of table 600 (FIG. 6)) for the routing of traffic of a UE. For example, the system 800 may exchange communications having the structure described in relation to table 100 (FIG. 1) between elements of the system 800 that can allow the elements to indicate and perform routing of traffic for UEs.

The system 800 may include one or more UEs, such as the UE 802. The UE 802 may include one or more of the features of the UE 702 (FIG. 7) and/or the UE 1200 (FIG. 12). For example, the UE 802 may include memory 804 and one or more processors 806, where the memory 804 can be utilized by the UE 802 same as the memory 704 (FIG. 7) is utilized by the UE 702 and the processors 806 can perform one or more of the same operations as the processors 706 (FIG. 7). The UE 802 may be configured with and/or store traffic descriptors in a same manner as the UE 702 is configured with and stores the traffic descriptors. For example, the UE 802 may be configured with the traffic descriptors at activation and/or production, may be configured with the traffic descriptors by a core network, or some combination thereof. The UE 802 may determine a traffic descriptor from the traffic descriptors to be utilized for traffic from the UE 802 and may provide the traffic descriptor in a communication.

The system 800 may include a base station 808. The base station 808 may include one or more of the features of the base station 710 (FIG. 7) and/or the gNB 1300 (FIG. 13). The base station 808 may receive the communication with the traffic descriptor from the UE 802. The base station 808 may identify the traffic descriptor within the communication. For example, the base station 808 may include a control plane 810, where the control plane 810 may identify the traffic descriptor. The control plane 810 may be able to determine a routing for traffic based on the traffic descriptor and/or traffic from the UE 802 to which the routing is to be applied.

The base station 808 may further include one or more user planes, where each of the user planes may be part of a network slice. In the illustrated example, the base station 808 includes a first user plane 812 that is part of a first network slice 818, a second user plane 814 that is part of a second network slice 820, and a third user plane 816 that is part of a third network slice 822. The traffic descriptor may indicate a user plane to which the traffic associated with the traffic descriptor is to be routed. For example, the traffic descriptor may explicitly indicate to which user plane the traffic is to be routed in some embodiments. In other embodiments, the traffic descriptor may indicate attributes for the traffic and the control plane 810 may determine to which user plane the traffic is to be directed based on the attributes.

Each of the network slices may provide services for UEs. In the illustrated example, the first network slice 818 includes a first AMF 824 and a first session management function (SMF) 826, the second network slice 820 includes a second AMF 828, and a second SMF 830, and the third network slice 822 includes a third AMF 832 and a third SMF 834. While each of the network slices are shown with AMFs and SMFs in the illustrated embodiment, it should be understood that the network slices may include different functions in other embodiments. The user plan may provide the traffic to the functions within the corresponding network, where the functions may provide services to the UE 802 based on the traffic. For example, traffic directed to the first user plane 812 may utilize the first AMF 824 and/or the first SMF 826 to provide services to the UE 802 based on the traffic.

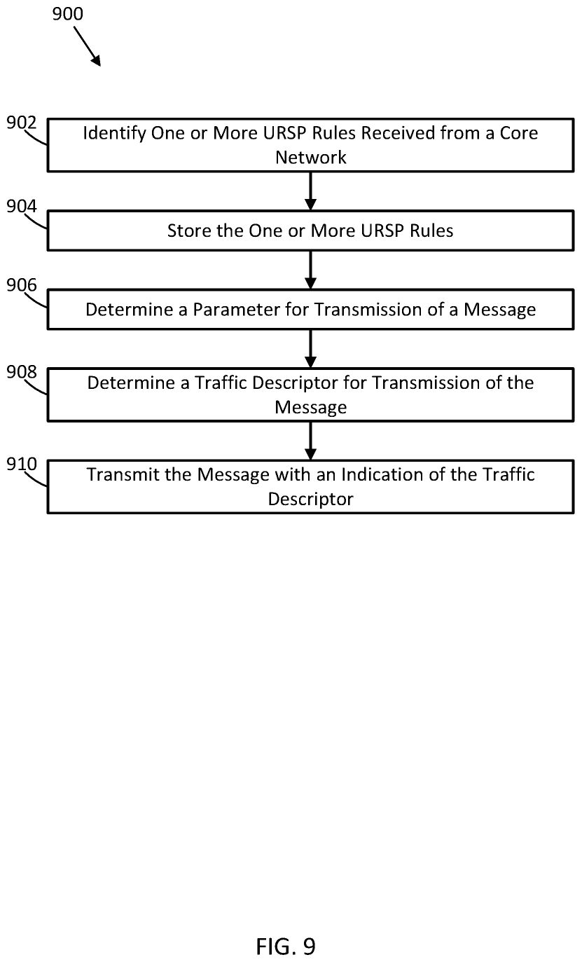

FIG. 9 illustrates an example procedure 900 providing a traffic descriptor for traffic in accordance with some embodiments. For example, the procedure 900 may be performed by a UE (such as the UE 702 (FIG. 7) and/or the UE 802 (FIG. 8)) to indicate a traffic descriptor for traffic of the UE and/or store traffic descriptors to be utilized for routing of traffic of the UE.

The procedure 900 may include identifying one or more URSP rules received from a core network in 902. For example, the UE may identify one or more URSP rules received from a core network (such as the core network 708 (FIG. 7)) as part of a registration of the UE. In other embodiments, the UE may identify one or more URSP rules (such as the URSP rules described in relation to table 100 (FIG. 1)) pushed to the UE by the core network. The URSP rules may be received in a NAS message from the core network. The URSP rules may include one or more traffic descriptors (such as the traffic descriptors 202 (FIG. 2), the traffic descriptors 302 (FIG. 3), the traffic descriptors 402 (FIG. 4), the traffic descriptors of table 500 (FIG. 5), and/or the traffic descriptors of table 600 (FIG. 6)), rules for determining a traffic descriptor to be utilized with traffic from the UE, one or more values corresponding to the traffic descriptors (such as the values 204 (FIG. 2), the values 304 (FIG. 3), the values 404 (FIG. 4), and/or the 5QI value 508 (FIG. 5)), and/or attributes corresponding to the traffic descriptors (such as the attributes described in relation to the table 300 (FIG. 3), the attributes described in relation to the table 400 (FIG. 4), the attributes of table 500 (FIG. 5), and/or the attributes of table 600 (FIG. 6)). In some embodiments, 902 may be omitted.

The procedure 900 may include storing the one or more URSP rules in a memory of the UE in 904. In particular, the UE may store the URSP rules in the memory of the UE. Further, the UE may store the traffic descriptors, the values, and/or the attributes received with the one or more URSP rules in the memory. The URSP rules may be stored for determining traffic descriptors for traffic of the UE. In some embodiments, 904 may be omitted.

The procedure 900 may further include determining a parameter for transmission of a message in 906. For example, the UE may determine a parameter for transmission of a message, the parameter being a service type or a QoS attribute. In particular, the UE may determine the parameter to be a service type in some embodiments, and may determine the parameter to be a QoS attribute is some embodiments. The service type may be an enterprise service type, a gaming service type, or a video streaming service type.

The procedure 900 may further include determining a traffic descriptor for transmission of the message in 908. For example, the UE may determine, based on one or more URSP rules and the parameter, a traffic descriptor for the transmission of the message.

In instances where the service type is determined to be the enterprise service type, determining the traffic descriptor may include determining, based on the service type being the enterprise service type, that the traffic descriptor is a voice traffic descriptor, an electronic mail traffic descriptor, a browser/chat traffic descriptor, or a conferencing traffic descriptor. In instances where the service type is determined to be the gaming service type, determining the traffic descriptor may include determining, based on the service type being the gaming service type, that the traffic descriptor is a real time gaming traffic descriptor, an interactive gaming traffic descriptor, or an augmented reality traffic descriptor. In instances where the service type is determined to be the video streaming service type, determining the traffic descriptor may include determining, based on the service type being the video streaming service type, that the traffic descriptor is a live streaming traffic descriptor, a buffered streaming traffic descriptor, an HD streaming traffic descriptor, or a 4K streaming traffic descriptor.

In instances, where the parameter is determined to be the QoS attribute, determining the traffic descriptor may include determining the traffic descriptor based on specified latencies, specified bandwidths, or specified packet error rates for the transmission of traffic associated with the message. Further, determining the traffic descriptor may include determining the traffic descriptor is an operator specific descriptor (such as an MNO specific descriptor) or an optimal QoS request descriptor in some embodiments.

The procedure 900 may include transmitting the message with an indication of the traffic descriptor in 910. For example, the UE may transmit the message with an indication of the traffic descriptor, where the traffic descriptor may be utilized for routing of traffic of the UE associate with the message. In some embodiments, the indication of the traffic descriptor may include a set of bits corresponding to the traffic descriptor.

While the procedure 900 is illustrated with a particular order for the operations, it should be understood that the operations may be performed in a different order or one or more of the operations may be performed concurrently in some embodiments. Further, additional operations as described throughout this disclosure may be added to the procedure 900 or one or more of the operations may be omitted from the procedure 900.

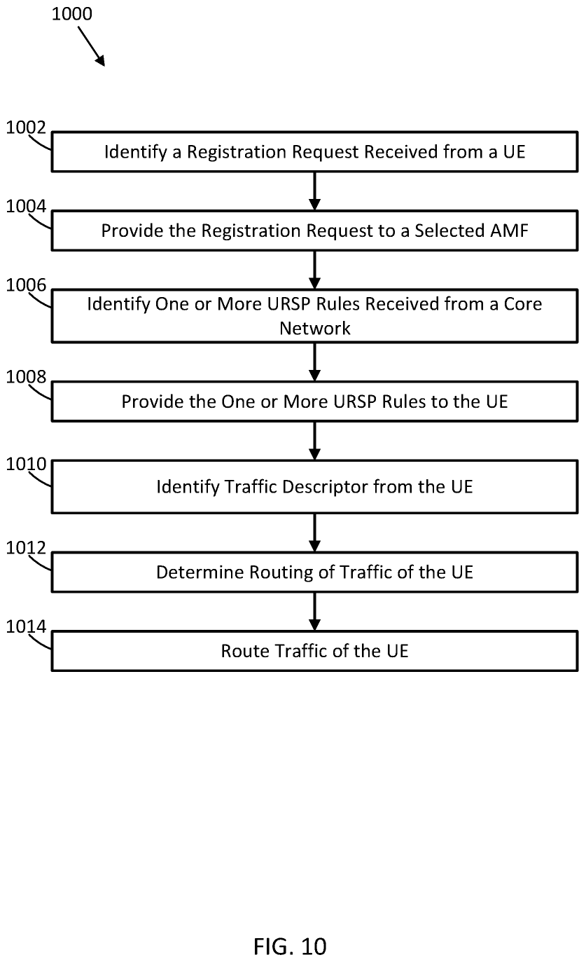

FIG. 10 illustrates an example procedure 1000 for routing traffic of a UE and/or providing URSP rules in accordance with some embodiments. The procedure 1000 may be performed by a network device. The network device may be a base station (such as the base station 710 (FIG. 7) and/or the base station 808 (FIG. 8)), a core network (such as the core network 708 (FIG. 7)), a device within a network slice (such as the first network slice 818 (FIG. 8), the second network slice 820 (FIG. 8), and/or the third network slice 822 (FIG. 8)), or some combination thereof.

The procedure 1000 may include identifying a registration request received from a UE in 1002. For example, the network device may identify a registration request transmitted by a UE (such as the UE 702 (FIG. 7) and/or the UE 802 (FIG. 8)) as part of a registration process of the UE. In some embodiments, 1002 may be omitted.

The procedure 1000 may include providing the registration request to a selected AMF in 1004. For example, the network device may provide the registration request to an AMF (such as the AMF 714 (FIG. 7)) of a core network (such as the core network 708 (FIG. 7)) or an AMF (such as the first AMF 824 (FIG. 8), the second AMF 828 (FIG. 8), and/or the third AMF 832 (FIG. 8)) of a network slice. In some embodiments, 1004 may be omitted.

The procedure 1000 may include identifying one or more URSP rules received from the core network in 1006. For example, the network device may identify one or more URSP rules received from the core network in response to the registration request. The URSP rules may be related to one or more traffic descriptors (such as the traffic descriptors 302 (FIG. 3), the traffic descriptors 402 (FIG. 4), the traffic descriptors of table 500 (FIG. 5), and/or the traffic descriptors of table 600 (FIG. 6)) for a parameter. The parameter may include a service type or a QoS attribute. In some embodiments, 1006 may be omitted.

The procedure 1000 may include providing the one or more URSP rules to the UE in 1008. For example, the network device may provide the one or more URSP rules identified in 1006 to the UE for storage by the UE. In some embodiments, 1008 may be omitted.

The procedure 1000 may include identifying a traffic descriptor from the UE in 1010. For example, the network device may identify a traffic descriptor corresponding to a service type or a QoS attribute within a message received from the UE. In particular, the traffic descriptor may correspond to a service type in some instances and may correspond to a QoS attribute in some instances. In some embodiments, the identified traffic descriptor may be from the traffic descriptors previously provided to the UE.

The service type may include an enterprise service type, a gaming service type, or a video streaming service type. In instances where the service type is the enterprise service type, the traffic descriptor may be determined to be a voice traffic descriptor, an electronic mail traffic descriptor, a browser/chat traffic descriptor, or a conferencing traffic descriptor. In instances where the service type is the gaming service type, the traffic descriptor may be determined to be a real time gaming traffic descriptor, an interactive gaming traffic descriptor, or an augmented reality traffic descriptor. In instances where the service type is the video streaming service type, the traffic descriptor may be determined to be a live streaming traffic descriptor, a buffered streaming traffic descriptor, an HD streaming traffic descriptor, or a 4K streaming traffic descriptor.

The QoS attribute may be defined by certain specified attributes. For example, the QoS attribute may be defined by specified latencies, specified bandwidths, specified packet errors, or some combination thereof.

The procedure 1000 may include determining routing of the traffic of the UE in 1012. For example, the network device may determine a routing of traffic of the UE from the network device based on the traffic descriptor. The traffic to be routed may be associated with the message with the traffic descriptor. The determined routing may be to particular resources within the core network, to a particular network slice, or some combination thereof.

The procedure 1000 may include routing the traffic of the UE in 1014. For example, the network device may route the traffic of the UE according to the determined routing from the network device.

While the procedure 1000 is illustrated with a particular order for the operations, it should be understood that the operations may be performed in a different order or one or more of the operations may be performed concurrently in some embodiments. Further, additional operations as described throughout this disclosure may be added to the procedure 1000 or one or more of the operations may be omitted from the procedure 1000.

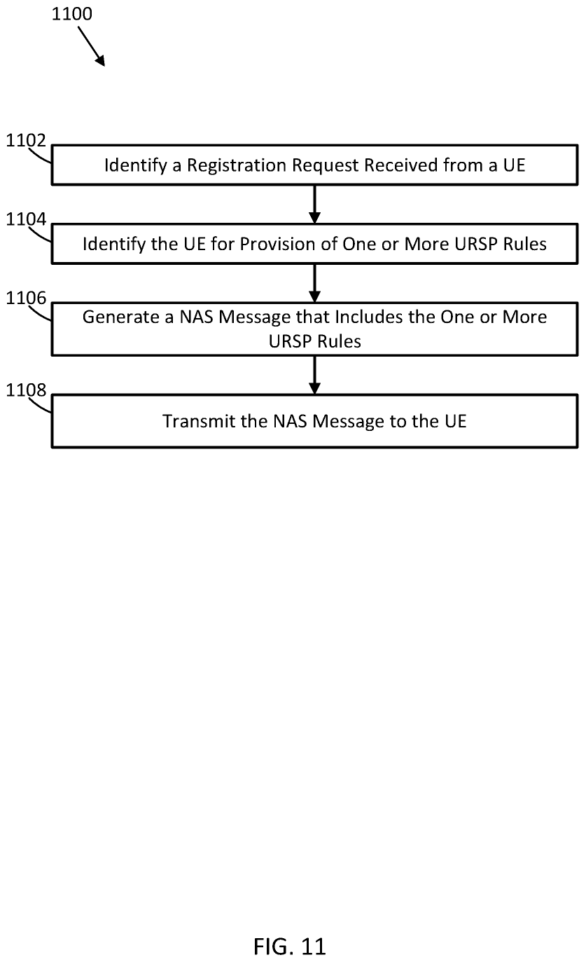

FIG. 11 illustrates an example procedure 1100 for provisioning URSP rules in accordance with some embodiments. The procedure 1100 may be performed by a core network (such as the core network 708 (FIG. 7)) or a portion of a network slice (such as the first network slice 818 (FIG. 8), the second network slice 820 (FIG. 8), and/or the third network slice 822 (FIG. 8)) that may include a core network or some portion thereof. For brevity, the core network or the portion of the network slice are collectively referred to as the core network throughout the description of the procedure 1100.

The procedure 1100 may include identifying a registration request received from a UE (such as the UE 702 (FIG. 7) and/or the UE 802 (FIG. 8)) in 1102. For example, the core network may identify a registration request received from the UE. The registration request may be provided from the UE to the core network as part of a process of the UE registering with the core network. In some embodiments, 1102 may be omitted.

The procedure 1100 may include identifying the UE for provisioning of one or more URSP rules in 1104. For example, the core network may identify the UE for provision of one or more URSP rules related to traffic descriptors for a parameter. The parameter may be a service type or a QoS attribute. For example, the parameter may be a service type in some instances and may be a QoS attribute in some instances.

The service type may be an enterprise service type, a gaming service type, or a video streaming service type. In instances where the service type is the enterprise service type, the traffic descriptors related to the URSP rules may include a voice traffic descriptor, an electronic mail traffic descriptor, a browser/chat traffic descriptor, or a conferencing traffic descriptor. In instances where the service type is the gaming service type, the traffic descriptors may include a real time gaming traffic descriptor, an interactive gaming traffic descriptor, or an augmented reality traffic descriptor. In instances where the service type is the video streaming service type, the traffic descriptors may include a live streaming traffic descriptor, a buffered streaming traffic descriptor, an HD streaming traffic descriptor or a 4K streaming traffic descriptor.

In instances where the parameter is a QoS attribute, the traffic descriptors for the QoS attribute may be defined based on specified attributes. For example, the traffic descriptors for the QoS attribute may be defined by specified latencies, specified bandwidths, or specified packet error rates.

In embodiments where the core network identifies the registration request received from the UE in 1102, the core network may identify the UE based on the registration request. For example, the core network may identify the UE for provision of the one or more URSP rules as part of a registration process of the UE with the core network.

The procedure 1100 may include generating a NAS message that includes the one or more URSP rules in 1106. For example, the core network may generate a NAS message that includes the one or more URSP rules for provision. The NAS message may include information of the structure described in relation to the table 100 (FIG. 1). For example, the NAS message may include traffic descriptors (such as the traffic descriptors 302 (FIG. 3), the traffic descriptors 402 (FIG. 4), the traffic descriptors of table 500 (FIG. 5), and/or the traffic descriptors of table 600 (FIG. 6)), values corresponding to the traffic descriptors (such as the values 304 (FIG. 3), the values 404 (FIG. 4), and/or the 5QI value 508 (FIG. 5)), and/or attributes corresponding to the traffic descriptors (such as the attributes described in relation to the table 300 (FIG. 3), the table 400 (FIG. 4), the table 500 (FIG. 5), and/or the table 600 (FIG. 6)).

The procedure 1100 may include transmitting the NAS message to the UE in 1108. For example, the core network may transmit the NAS message to the UE. In some embodiments, the NAS message may be transmitted through a base station (such as the base station 710 (FIG. 7) and/or the base station 808 (FIG. 8)). In instances where the core network identifies the registration request in 1102, the core network may transmit the NAS message to the UE in response to the registration request. In some instances, transmitting the NAS message to the UE may include pushing the NAS message from an AMF (such as the AMF 714 (FIG. 7), the first AMF 824 (FIG. 8), the second AMF 828 (FIG. 8), and/or the third AMF 832 (FIG. 8)) of the core network to the UE.

While the procedure 1100 is illustrated with a particular order for the operations, it should be understood that the operations may be performed in a different order or one or more of the operations may be performed concurrently in some embodiments. Further, additional operations as described throughout this disclosure may be added to the procedure 1100 or one or more of the operations may be omitted from the procedure 1100.

FIG. 12 illustrates an example UE 1200 in accordance with some embodiments. The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 1200 may be a RedCap UE or NR-Light UE.

The UE 1200 may include processors 1204, RF interface circuitry 1208, memory/storage 1212, user interface 1216, sensors 1220, driver circuitry 1222, power management integrated circuit (PMIC) 1224, antenna structure 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1232, which may represent any type of interface, input/output, bus (local, system, or expansion), transmission line, trace, optical connection, etc. that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein. The memory/storage 1212 include any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, phased array antennas, etc. The antenna 1226 may have one or more panels designed for specific frequency bands including bands in FR1 or FR2.

The user interface circuitry 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensor circuitry 1220 and control and allow access to sensor circuitry 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

In some embodiments, the PMIC 1224 may control, or otherwise be part of, various power saving mechanisms of the UE 1200. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1200 may power down for brief intervals of time and thus save power. If there is no data traffic activity for an extended period of time, then the UE 1200 may transition off to an RRC Idle state, where it disconnects from the network and does not perform operations such as channel quality feedback, handover, etc. The UE 1200 goes into a very low power state and it performs paging where again it periodically wakes up to listen to the network and then powers down again. The UE 1200 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1228 may power the UE 1200, although in some examples the UE 1200 may be mounted deployed in a fixed location, and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

FIG. 13 illustrates an example gNB 1300 in accordance with some embodiments. The gNB 1300 may include processors 1304, RF interface circuitry 1308, core network (CN) interface circuitry 1312, memory/storage circuitry 1316, and antenna structure 1326.

The components of the gNB 1300 may be coupled with various other components over one or more interconnects 1328.

The processors 1304, RF interface circuitry 1308, memory/storage circuitry 1316 (including communication protocol stack 1310), antenna structure 1326, and interconnects 1328 may be similar to like-named elements shown and described with respect to FIG. 12.

The CN interface circuitry 1312 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1300 via a fiber optic or wireless backhaul. The CN interface circuitry 1312 may include one or more dedicated processors or FPGAs to communicate using one or more of the aforementioned protocols. In some implementations, the CN interface circuitry 1312 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.
Example 1 may include a method, comprising determining a parameter for transmission of a message, the parameter being a service type or a quality of service (QoS) attribute, determining, based on one or more user equipment route selection policy (URSP) rules and the parameter, a traffic descriptor for the transmission of the message, and transmitting the message with an indication of the traffic descriptor, wherein the traffic descriptor is utilized for routing of traffic of the UE associated with the message.
Example 2 may include the method of example 1, wherein determining the parameter comprises determining the service type for the transmission of the message, and wherein determining the service type comprises determining the service type is an enterprise service type, a gaming service type, or a video streaming service type.
Example 3 may include the method of example 2, wherein the traffic descriptor is expressed in terms of one or more QoS attributes comprising a priority, a packet delay, an error rate, a burst volume, or an averaging window.
Example 4 may include the method of example 2, wherein determining the service type includes determining the service type is the enterprise service type, and wherein determining the traffic descriptor comprises determining, based on the service type being the enterprise service type, that the traffic descriptor is a voice traffic descriptor, an electronic mail traffic descriptor, a browser/chat traffic descriptor, or a conferencing traffic descriptor.
Example 5 may include the method of example 4, wherein the enterprise service type is of type best effort that can support various enterprise applications.
Example 6 may include the method of example 2, wherein determining the service type includes determining the service type is the gaming service type, and wherein determining the traffic descriptor comprises to determine, based on the service type being the gaming service type, that the traffic descriptor is a real time gaming traffic descriptor, an interactive gaming traffic descriptor, or an augmented reality traffic descriptor.
Example 7 may include the method of example 2, wherein determining the service type includes determining the service type is the video streaming service type, and wherein determining the traffic descriptor comprises determining, based on the service type being the video streaming service type, that the traffic descriptor is a live streaming traffic descriptor, a buffered streaming traffic descriptor, a high-definition streaming traffic descriptor, or a 4K streaming traffic descriptor.
Example 8 may include the method of example 1, wherein determining the parameter comprises determining the QoS attribute for the transmission of the message.
Example 9 may include the method of example 8, wherein determining the traffic descriptor for the transmission of the message comprises determining the traffic descriptor based on specified latencies, specified bandwidths, specified packet error rates or whether the traffic is defined to be managed.
Example 10 may include the method of example 9, wherein the traffic descriptor is determined to be a real-time online interaction traffic descriptor based on a specification of low latency, normal data loss, and low bandwidth.
Example 11 may include the method of example 9, wherein the traffic descriptor is determined to be a default bearer traffic descriptor based on a specification of normal latency, normal data loss, and normal bandwidth.
Example 12 may include the method of example 9, wherein the traffic descriptor is determined to be a video streaming traffic descriptor based on a specification of high latency, low data loss, and high bandwidth.
Example 13 may include the method of example 9, wherein the traffic descriptor is determined to be an augmented reality/virtual reality traffic descriptor based on a specification of high latency, normal data loss, and high bandwidth.
Example 14 may include the method of example 9, wherein the traffic descriptor is determined to be a background traffic descriptor based on a specification of high latency, normal data loss, and normal bandwidth.
Example 15 may include the method of example 9, wherein the traffic descriptor is determined to be an alternative traffic descriptor based on a specification of high latency, high data loss, and normal bandwidth.
Example 16 may include the method of example 1, wherein determining the traffic descriptor includes determining that the traffic descriptor is an operator specific descriptor or an optimal QoS request descriptor.
Example 17 may include the method of example 1, further comprising identifying the one or more URSP rules received from a core network as part of a registration of the UE, and storing the one or more URSP rules in a memory of the UE.
Example 18 may include the method of example 1, wherein the indication of the traffic descriptor comprises a set of bits corresponding to the traffic descriptor.
Example 19 may include the method of example 18, wherein the set of bits corresponds to a traffic descriptor component type identifier in the one or more URSP rules.
Example 20 may include a method, comprising identifying a traffic descriptor corresponding to a service type or a QoS attribute within a message received from a user equipment (UE), determining, based on the traffic descriptor, routing of traffic of the UE from the network device, and routing traffic of the UE according to the determined routing from the network device.
Example 21 may include the method of example 20, wherein the traffic descriptor corresponds to the service type, and wherein the service type is an enterprise service type, a gaming service type, or a video streaming service type.
Example 22 may include the method of example 21, wherein the service type is the enterprise service type, and wherein the traffic descriptor for the enterprise service type is a voice traffic descriptor, an electronic mail traffic descriptor, a browser/chat traffic descriptor, or a conferencing traffic descriptor.
Example 23 may include the method of example 22, wherein the enterprise service type is of type best effort that can support various enterprise applications.
Example 24 may include the method of example 21, wherein the service type is the gaming service type, and wherein the traffic descriptor for the gaming service type is a real time gaming traffic descriptor, an interactive gaming traffic descriptor, or an augmented reality traffic descriptor.
Example 25 may include the method of example 21, wherein the service type is the video streaming service type, and wherein the traffic descriptor for the video streaming service type is a live streaming traffic descriptor, a buffered streaming traffic descriptor, a high-definition streaming traffic descriptor, or a 4K streaming traffic descriptor.
Example 26 may include the method of example 20, wherein the traffic descriptor is for the QoS attribute, and wherein the traffic descriptor for the QoS attribute is defined by specified latencies, specified bandwidths, or specified packet error rates.
Example 27 may include the method of example 20, further comprising identifying a registration request received from the UE, providing the registration request to a selected access and mobility management function (AMF) of a core network, identifying one or more UE route selection policy (URSP) rules received from the core network in response to the registration request, the one or more URSP rules related to one or more traffic descriptors for a parameter, wherein the one or more traffic descriptors includes the traffic descriptor, and wherein the parameter includes the service type or the QoS attribute, and providing the one or more URSP rules to the UE for storage by the UE.
Example 28 may include a method, comprising identifying a user equipment (UE) for provision of one or more user equipment route selection policy (URSP) rules related to traffic descriptors for a parameter, the parameter being a service type or a quality of service (QoS) attribute, generating a non-access stratum (NAS) message that includes the one or more URSP rules, and transmitting the NAS message to the UE.
Example 29 may include the method of example 28, wherein the parameter is the service type, and wherein the service type is an enterprise service type, a gaming service type, or a video streaming service type.
Example 30 may include the method of example 29, wherein the service type is the enterprise service type, and wherein the traffic descriptors for the enterprise service type include a voice traffic descriptor, an electronic mail traffic descriptor, a browser/chat traffic descriptor, or a conferencing traffic descriptor.
Example 31 may include the method of example 30, wherein the enterprise service type is of type best effort that can support various enterprise applications.
Example 32 may include the method of example 29, wherein the service type is the gaming service type, and wherein the traffic descriptors for the gaming service type include a real time gaming traffic descriptor, an interactive gaming traffic descriptor, or an augmented reality traffic descriptor.
Example 33 may include the method of example 29, wherein the service type is the video streaming service type, and wherein the traffic descriptors for the video streaming service type include a live streaming traffic descriptor, a buffered streaming traffic descriptor, a high-definition streaming traffic descriptor, or 4K streaming traffic descriptor.
Example 34 may include the method of example 28, wherein the parameter is the QoS attribute, and wherein the traffic descriptors for the QoS attribute are defined by specified latencies, specified bandwidths, or specified packet error rates.
Example 35 may include the method of example 28, further comprising identifying a registration request received from the UE, wherein identifying the UE comprises identifying the UE based on the registration request, and wherein the NAS message is transmitted to the UE in response to the registration request.
Example 36 may include the method of example 28, wherein transmitting the NAS message to the UE includes pushing the NAS message from an access and mobility management function (AMF) of the core network to the UE.
Example 37 may include an apparatus comprising means to perform one or more elements of a method described in or related to any of examples 1-36, or any other method or process described herein.
Example 38 may include one or more non-transitory computer-readable media comprising instructions to cause an electronic device, upon execution of the instructions by one or more processors of the electronic device, to perform one or more elements of a method described in or related to any of examples 1-36, or any other method or process described herein.
Example 39 may include an apparatus comprising logic, modules, or circuitry to perform one or more elements of a method described in or related to any of examples 1-36, or any other method or process described herein.
Example 40 may include a method, technique, or process as described in or related to any of examples 1-36, or portions or parts thereof.
Example 41 may include an apparatus comprising: one or more processors and one or more computer-readable media comprising instructions that, when executed by the one or more processors, cause the one or more processors to perform the method, techniques, or process as described in or related to any of examples 1-36, or portions thereof
Example 42 may include a signal as described in or related to any of examples 1-36, or portions or parts thereof.
Example 43 may include a datagram, information element, packet, frame, segment, PDU, or message as described in or related to any of examples 1-36, or portions or parts thereof, or otherwise described in the present disclosure.
Example 44 may include a signal encoded with data as described in or related to any of examples 1-36, or portions or parts thereof, or otherwise described in the present disclosure.
Example 45 may include a signal encoded with a datagram, IE, packet, frame, segment, PDU, or message as described in or related to any of examples 1-36, or portions or parts thereof, or otherwise described in the present disclosure.
Example 46 may include an electromagnetic signal carrying computer-readable instructions, wherein execution of the computer-readable instructions by one or more processors is to cause the one or more processors to perform the method, techniques, or process as described in or related to any of examples 1-36, or portions thereof
Example 47 may include a computer program comprising instructions, wherein execution of the program by a processing element is to cause the processing element to carry out the method, techniques, or process as described in or related to any of examples 1-36, or portions thereof.
Example 48 may include a signal in a wireless network as shown and described herein.
Example 49 may include a method of communicating in a wireless network as shown and described herein.
Example 50 may include a system for providing wireless communication as shown and described herein.
Example 51 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory computer-readable media having instructions that, when executed by one or more processors, cause a user equipment (UE) to:
determine a parameter for transmission of a message, the parameter being a service type or a quality of service (QoS) attribute;
determine, based on one or more user equipment route selection policy (URSP) rules and the parameter, a traffic descriptor for the transmission of the message; and
transmit the message with an indication of the traffic descriptor, wherein the traffic descriptor is utilized for routing of traffic of the UE associated with the message.

2. The one or more non-transitory computer-readable media of claim 1, wherein to determine the parameter comprises to determine the service type for the transmission of the message, and wherein to determine the service type comprises to determine the service type is an enterprise service type, a gaming service type, or a video streaming service type.

3. The one or more non-transitory computer-readable media of claim 2, wherein to determine the service type includes to determine the service type is the enterprise service type, and wherein to determine the traffic descriptor comprises to determine, based on the service type being the enterprise service type, that the traffic descriptor is a voice traffic descriptor, an electronic mail traffic descriptor, a browser/chat traffic descriptor, or a conferencing traffic descriptor.

4. The one or more non-transitory computer-readable media of claim 3, wherein the enterprise service type is of type best effort that can support various enterprise applications.

5. The one or more non-transitory computer-readable media of claim 2, wherein to determine the service type includes to determine the service type is the gaming service type, and wherein to determine the traffic descriptor comprises to determine, based on the service type being the gaming service type, that the traffic descriptor is a real time gaming traffic descriptor, an interactive gaming traffic descriptor, or an augmented reality traffic descriptor.

6. The one or more non-transitory computer-readable media of claim 2, wherein to determine the service type includes to determine the service type is the video streaming service type, and wherein to determine the traffic descriptor comprises to determine, based on the service type being the video streaming service type, that the traffic descriptor is a live streaming traffic descriptor, a buffered streaming traffic descriptor, a high-definition streaming traffic descriptor, or a 4K streaming traffic descriptor.

7. The one or more non-transitory computer-readable media of claim 1, wherein to determine the parameter comprises to determine the QoS attribute for the transmission of the message.

8. A network device comprising:
one or more processors to:
identify a traffic descriptor corresponding to a service type or a QoS attribute within a message received from a user equipment (UE); and
determine, based on the traffic descriptor, routing of traffic of the UE from the network device; and
core network (CN) interface circuitry coupled to the one or more processors, the CN interface circuitry to:
route traffic of the UE according to the determined routing from the network device.

9. The network device of claim 8, wherein the traffic descriptor corresponds to the service type, and wherein the service type is an enterprise service type, a gaming service type, or a video streaming service type.

10. The network device of claim 9, wherein the service type is the enterprise service type, and wherein the traffic descriptor for the enterprise service type is a voice traffic descriptor, an electronic mail traffic descriptor, a browser/chat traffic descriptor, or a conferencing traffic descriptor.

11. The network device of claim 10, wherein the enterprise service type is of type best effort that can support various enterprise applications.

12. The network device of claim 9, wherein the service type is the gaming service type, and wherein the traffic descriptor for the gaming service type is a real time gaming traffic descriptor, an interactive gaming traffic descriptor, or an augmented reality traffic descriptor.

13. The network device of claim 9, wherein the service type is the video streaming service type, and wherein the traffic descriptor for the video streaming service type is a live streaming traffic descriptor, a buffered streaming traffic descriptor, a high-definition streaming traffic descriptor, or a 4K streaming traffic descriptor.

14. A method of operating a core network comprising:
identifying a user equipment (UE) for provision of one or more user equipment route selection policy (URSP) rules related to traffic descriptors for a parameter, the parameter being a service type or a quality of service (QoS) attribute;
generating a non-access stratum (NAS) message that includes the one or more URSP rules; and
transmitting the NAS message to the UE.

15. The method of claim 14, wherein the parameter is the service type, and wherein the service type is an enterprise service type, a gaming service type, or a video streaming service type.

16. The method of claim 15, wherein the service type is the enterprise service type, and wherein the traffic descriptors for the enterprise service type include a voice traffic descriptor, an electronic mail traffic descriptor, a browser/chat traffic descriptor, or a conferencing traffic descriptor.

17. The method of claim 16, wherein the enterprise service type is of type best effort that can support various enterprise applications.

18. The method of claim 15, wherein the service type is the gaming service type, and wherein the traffic descriptors for the gaming service type include a real time gaming traffic descriptor, an interactive gaming traffic descriptor, or an augmented reality traffic descriptor.

19. The method of claim 15, wherein the service type is the video streaming service type, and wherein the traffic descriptors for the video streaming service type include a live streaming traffic descriptor, a buffered streaming traffic descriptor, a high-definition streaming traffic descriptor, or 4K streaming traffic descriptor.

20. The method of claim 14, wherein the parameter is the QoS attribute, and wherein the traffic descriptors for the QoS attribute are defined by specified latencies, specified bandwidths, or specified packet error rates.
